(19) United States
(12) Patent Application Publication
(10) Pub. No.: US 2026/0276054 A1
(43) Pub. Date: Sep. 17, 2026

(54) SHOCK ABSORBER AND DAMPING FORCE GENERATION MECHANISM

(71) Applicant: Hitachi Astemo, Ltd., Ibaraki (JP)

(72) Inventor: Yuta YAMAGUCHI, Hitachinaka-shi (JP)

(21) Appl. No.: 19/109,595

(22) PCT Filed: Sep. 13, 2023
(86) PCT No.: PCT/JP2023/033353

§ 371 Date: Mar. 7, 2025

(30) Foreign Application Priority Data
Nov. 28, 2022 (JP) 2022-189298

(51) Int. Cl. F16F 9/504; B60G 13/08; B60G 17/08; F16F 9/18; F16F 9/348

(52) U.S. Cl. CPC F16F 9/504; F16F 9/185; F16F 9/3484; B60G 13/08; B60G 17/08; B60G 2202/24; B60G 2204/62; B60G 2206/41; B60G 2500/104; B60G 2500/11; B60G 2600/21; B60G 2800/162; B60G 2800/916; F16F 2222/12; F16F 2228/066; F16F 2230/18; F16F 2232/08; F16F 2234/02

(57) ABSTRACT

This shock absorber includes a cylinder in which a working fluid is sealed, a piston fitted into the cylinder to be slidable and partitioning an inside of the cylinder into a first cylinder chamber and a second cylinder chamber, a first passage through which the working fluid flows from one chamber in the cylinder due to movement of the piston, a second passage provided parallel to the first passage, a valve mechanism provided in the first passage and operating when the first cylinder chamber is at an upstream pressure to allow a damping force to be adjusted by a pressure in a main-back pressure chamber, a frequency sensitive mechanism provided in the second passage and operating when the first cylinder chamber is at an upstream pressure to vary a volume according to movement of a movable member, a check valve provided in the second passage.

### TECHNICAL FIELD

The present invention relates to a shock absorber and a damping force generation mechanism.

Priority is claimed on Japanese Patent Application No. 2022-189298 filed on Nov. 28, 2022, the contents of which are incorporated herein by reference.

### BACKGROUND ART

Some shock absorbers have a damping force generation mechanism in which a damping force is variable in response to a frequency (see, for example, Patent Document 1).

### CITATION LIST

### Patent Document

Patent Document 1: Japanese Unexamined Patent Application, First Publication No. 2021-55850

### SUMMARY OF INVENTION

### Technical Problem

In a shock absorber, it is required that a damping force generation mechanism operate smoothly.

Therefore, the present invention provides a shock absorber and a damping force generation mechanism that allow a smooth operation of the damping force generation mechanism.

### Solution to Problem

A shock absorber according to a first aspect of the present invention includes a cylinder in which a working fluid is sealed, a piston fitted into the cylinder to be slidable and partitioning an inside of the cylinder into a first cylinder chamber and a second cylinder chamber, a first passage through which the working fluid flows from one chamber in the cylinder due to movement of the piston, a second passage provided parallel to the first passage, a valve mechanism provided in the first passage and operating when the first cylinder chamber is at an upstream pressure to allow a damping force to be adjusted by a pressure in a main-back pressure chamber, a frequency sensitive mechanism provided in the second passage and operating when the first cylinder chamber is at an upstream pressure to vary a volume according to movement of a movable member, a check valve provided in the second passage and operating when the second cylinder chamber is at an upstream pressure, and a first throttle mechanism provided downstream or upstream of the check valve and operating when the second cylinder chamber is at an upstream pressure to control a flow of the working fluid to the main-back pressure chamber.

A damping force generation mechanism according to a second aspect of the present invention includes a biasing force generation member having a bottomed cylindrical shape and forming a back pressure chamber which generates a biasing force in a valve closing direction on a damping force generation member disposed on an opening side, a valve provided at a bottom portion of the biasing force generation member, defining a variable chamber on a side opposite to the back pressure chamber, and blocking a flow of a working fluid from the back pressure chamber to the variable chamber, and a restriction member coming into contact with an outer circumferential side of the valve to restrict opening of the valve, wherein the valve has a first throttle portion restricting an inflow of the working fluid from the variable chamber to the back pressure chamber.

### Advantageous Effects of Invention

According to the aspects described above, it is possible to operate the damping force generation mechanism smoothly.

### BRIEF DESCRIPTION OF DRAWINGS

FIG. 1 A cross-sectional view showing a shock absorber of a first embodiment according to the present invention.

FIG. 2 A cross-sectional view showing a damping force generation mechanism of the shock absorber of the first embodiment according to the present invention.

FIG. 3 A cross-sectional view showing a configuration of a main portion of the shock absorber of the first embodiment according to the present invention.

FIG. 4 A cross-sectional view showing a configuration of a main portion of the shock absorber of the first embodiment according to the present invention.

FIG. 5 A bottom view showing a pilot case of the shock absorber of the first embodiment according to the present invention.

FIG. 6 A hydraulic circuit diagram showing a configuration of a main portion of the shock absorber of the first embodiment according to the present invention.

FIG. 7 A cross-sectional view showing a configuration of a main portion of a shock absorber of a second embodiment according to the present invention.

FIG. 8 A cross-sectional view showing a configuration of a main portion of a shock absorber of a third embodiment according to the present invention.

FIG. 9 A bottom view showing a pilot case of the shock absorber of the third embodiment according to the present invention.

FIG. 10 A hydraulic circuit diagram showing a configuration of a main portion of the shock absorber of the third embodiment according to the present invention.

FIG. 11 A cross-sectional view showing another application example of the configuration of the shock absorber of the third embodiment according to the present invention.

FIG. 12 A cross-sectional view showing a configuration of a main portion of another application example of the configuration of the shock absorber of the third embodiment according to the present invention.

### DESCRIPTION OF EMBODIMENTS

### First embodiment

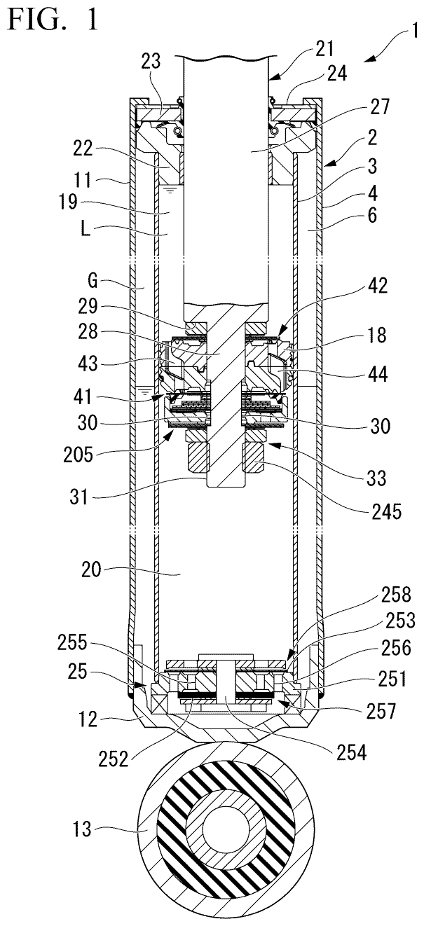

A shock absorber of a first embodiment will be described below with reference to FIGS. 1 to 6. In the following, for convenience of explanation, an upper side in FIGS. 1 to 4, 6 to 8, and 10 to 12 will be referred to with “upper,” and a lower side in FIGS. 1 to 4, 6 to 8, and 10 to 12 will be referred to with “lower”.

As shown in FIG. 1, a shock absorber 1 is a dual-tube type hydraulic shock absorber. The shock absorber 1 is used in suspension devices of vehicles. The shock absorber 1 includes a cylinder 2 in which an oil fluid L is sealed as a working fluid. The cylinder 2 has an inner cylinder 3 and an outer cylinder 4. The inner cylinder 3 has a cylindrical shape. The outer cylinder 4 has a bottomed cylindrical shape. The outer cylinder 4 has an inner diameter larger than an outer diameter of the inner cylinder 3. The inner cylinder 3 is disposed inside of the outer cylinder 4. A central axis of the inner cylinder 3 and a central axis of the outer cylinder 4 coincide with each other. A reservoir chamber 6 is formed between the inner cylinder 3 and the outer cylinder 4.

The outer cylinder 4 includes a barrel member 11 and a bottom member 12. The barrel member 11 has a cylindrical shape. The bottom member 12 has a bottomed cylindrical shape. The bottom member 12 is fitted to a lower side of the barrel member 11 and fixed to the barrel member 11 by welding. The bottom member 12 closes a lower part of the barrel member 11. A mounting eye 13 is fixed by welding to the bottom member 12 on an outer side opposite to the barrel member 11 in an axial direction thereof.

The shock absorber 1 includes a piston 18. The piston 18 is slidably fitted into the inner cylinder 3 of the cylinder 2. The piston 18 partitions the inside of the inner cylinder 3 into two chambers, an upper chamber 19 (first cylinder chamber) and a lower chamber 20 (second cylinder chamber). In an axial direction of the cylinder 2, the upper chamber 19 is on a side opposite to the bottom member 12 with respect to the piston 18. In the axial direction of the cylinder 2, the lower chamber 20 is on the bottom member 12 side with respect to the piston 18. The oil fluid L is sealed in the upper chamber 19 and the lower chamber 20 in the inner cylinder 3 as a working fluid. The oil fluid L and a gas G are sealed in the reservoir chamber 6 between the inner cylinder 3 and the outer cylinder 4 as a working fluid.

The shock absorber 1 includes a piston rod 21. One end side of the piston rod 21 in an axial direction thereof is disposed inside the inner cylinder 3 of the cylinder 2. This one end part of the piston rod 21 is connected to the piston 18. The other end part side of the piston rod 21 on a side opposite to the one end part in the axial direction extends from the cylinder 2 to the outside of the cylinder 2. The piston 18 is fixed to the piston rod 21. Therefore, the piston 18 and the piston rod 21 move together. In the shock absorber 1, a stroke in which the piston rod 21 moves in a direction to increase an amount of protrusion from the cylinder 2 is referred to as an extension stroke in which the entire length increases. In the shock absorber 1, a stroke in which the piston rod 21 moves in a direction to decrease an amount of protrusion from the cylinder 2 is referred to as a compression stroke in which the entire length decreases. In the shock absorber 1, the piston 18 moves to the upper chamber 19 side during the extension stroke. In the shock absorber 1, the piston 18 moves to the lower chamber 20 side during the compression stroke.

A rod guide 22 is fitted to an upper end opening side of the inner cylinder 3 and an upper end opening side of the outer cylinder 4. A seal member 23 is fitted into the outer cylinder 4 on an upper side of the rod guide 22. A disc 24 is fitted into the outer cylinder 4 on an upper side of the seal member 23. The rod guide 22 and the seal member 23 are both annular. The disc 24 has a bored circular flat plate shape with a constant thickness. The disc 24 is in contact with a portion on an outer circumferential side of the seal member 23. The piston rod 21 slides with respect to the rod guide 22 and the seal member 23 in an axial direction of these. The piston rod 21 extends from the inside of the cylinder 2 to the outside of the cylinder 2 with respect to the seal member 23.

The rod guide 22 restricts movement of the piston rod 21 in a radial direction with respect to the inner cylinder 3 and outer cylinder 4 of the cylinder 2. The piston rod 21 is fitted in the rod guide 22, and the piston 18 is fitted in the inner cylinder 3. Thereby, a central axis of the piston rod 21 and a central axis of the cylinder 2 coincide with each other. The rod guide 22 supports the piston rod 21 to be movable in an axial direction of the piston rod 21. An outer circumferential portion of the seal member 23 is in close contact with the outer cylinder 4. An inner circumferential portion of the seal member 23 is in close contact with an outer circumferential portion of the piston rod 21. The piston rod 21 moves in an axial direction of the seal member 23 with respect to the seal member 23. The seal member 23 curbs the oil fluid L in the inner cylinder 3 and the high-pressure gas and the oil fluid L in the reservoir chamber 6 leaking to the outside.

An outer circumferential portion of the rod guide 22 has a larger diameter at an upper part than at a lower part. The rod guide 22 is fitted to an inner circumferential portion of an upper end of the inner cylinder 3 at the lower part with the smaller diameter. The rod guide 22 is fitted to an upper inner circumferential portion of the outer cylinder 4 at the upper part with the larger diameter. A base valve 25 is installed on the bottom member 12 of the outer cylinder 4. The base valve 25 is positioned in the radial direction with respect to the outer cylinder 4. The base valve 25 partitions the lower chamber 20 and the reservoir chamber 6. An inner circumferential portion of a lower end of the inner cylinder 3 is fitted to the base valve 25. An upper end part of the outer cylinder 4 is swaged inward in the radial direction of the outer cylinder 4. The seal member 23, together with the disc 24, is fixed to the cylinder 2 by being sandwiched between the swaged portion and the rod guide 22.

The piston rod 21 includes a main shaft portion 27 and a mounting shaft portion 28. The mounting shaft portion 28 has an outer diameter smaller than an outer diameter of the main shaft portion 27. The mounting shaft portion 28 is disposed inside the cylinder 2. The piston 18 of the piston rod 21 is attached to the mounting shaft portion 28. The main shaft portion 27 of the piston rod 21 slides relative to the rod guide 22 and the seal member 23. The main shaft portion 27 has a shaft step portion 29. The shaft step portion 29 is provided at an end part of the main shaft portion 27 on the mounting shaft portion 28 side. The shaft step portion 29 extends in a direction orthogonal to the central axis of the piston rod 21.

A passage groove 30 is formed in the piston rod 21 on an outer circumferential portion of the mounting shaft portion 28. The passage groove 30 is formed by notching the outer circumferential portion of the mounting shaft portion 28 into a planar shape parallel to a central axis of the mounting shaft portion 28. The passage groove 30 extends in an axial direction of the mounting shaft portion 28. A plurality of, specifically two, passage grooves 30 are formed at regular intervals in a circumferential direction of the mounting shaft portion 28. A male screw 31 is formed on an outer circumferential portion of an end part of the mounting shaft portion 28 on a side opposite to the main shaft portion 27 with respect to the passage grooves 30 in the axial direction of the mounting shaft portion 28.

The shock absorber 1 is connected to a vehicle body of a vehicle, for example, with a portion of the piston rod 21 protruding from the cylinder 2 disposed at an upper part. At that time, the shock absorber 1 is connected to a wheel side of the vehicle with the mounting eye 13, which is provided on the cylinder 2 side, disposed at a lower part. Conversely, the cylinder 2 side of the shock absorber 1 may be connected to the vehicle body in a case in which the shock absorber 1 is of a single-tube type rather than a dual-cylinder type. In this case, the piston rod 21 of the shock absorber 1 is connected to the wheel side.

In the vehicle, the wheel vibrates with respect to the vehicle body as the vehicle travels. Then, in the shock absorber 1, relative positions of the cylinder 2 and the piston rod 21 change according to the vibration. This change is suppressed by fluid resistance in a flow path provided in the shock absorber 1. As will be described below, the fluid resistance in the flow path provided in the shock absorber 1 is designed to be different according to a speed or an amplitude of the vibration described above. Ride comfort of the vehicle is improved by the shock absorber 1 suppressing the vibration.

Also, in the vehicle, an inertial force or a centrifugal force generated in the vehicle body as the vehicle travels also acts between the cylinder 2 and the piston rod 21 in addition to the vibration generated by the wheel with respect to the vehicle body. For example, a centrifugal force is generated in the vehicle body when a traveling direction is changed by a steering wheel operation. Then, a force based on the centrifugal force acts between the cylinder 2 and the piston rod 21. As will be described below, the shock absorber 1 has satisfactory characteristics against vibration based on the force generated in the vehicle body as the vehicle travels. High traveling stability of the vehicle can be obtained by the shock absorber 1.

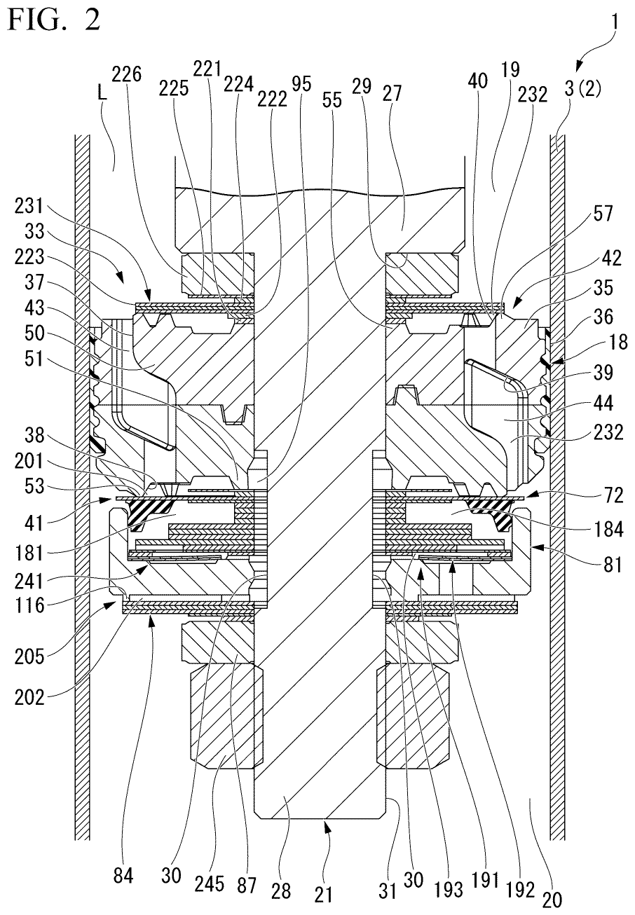

The shock absorber 1 has a damping force generation mechanism 33. The damping force generation mechanism 33 includes the piston 18 and has a configuration shown in FIG. 2.

The piston 18 includes a piston main body 35 and a slide member 36. The piston main body 35 is made of a metal and has an annular shape. The piston main body 35 of the piston 18 is fitted onto the mounting shaft portion 28 of the piston rod 21. The slide member 36 is made of a synthetic resin and has an annular shape. The slide member 36 is integrally attached to an outer circumferential surface of the piston main body 35. The piston 18 slides with respect to the inner cylinder 3 with the slide member 36 in contact with the inner cylinder 3.

A passage hole 37, a passage groove 38, a passage hole 39, and a passage groove 40 are provided in the piston main body 35. The passage hole 37 penetrates the piston main body 35 in an axial direction of the piston main body 35. A plurality of passage holes 37 are formed in the piston main body 35 at intervals in a circumferential direction of the piston main body 35. The passage hole 39 penetrates the piston main body 35 in the axial direction of the piston main body 35. A plurality of passage holes 39 are formed in the piston main body 35 at intervals in the circumferential direction of the piston main body 35. In the piston main body 35, the passage holes 37 and the passage holes 39 are alternately formed one by one at a regular pitch in the circumferential direction of the piston main body 35.

The passage groove 38 is formed in the piston main body 35 in an annular shape in the circumferential direction of the piston main body 35. The passage groove 38 is formed at an end part of the piston main body 35 on the lower chamber 20 side in the axial direction. All the passage holes 37 open to the passage groove 38 at this end part side of the piston main body 35 in the axial direction. The passage groove 40 is formed in the piston main body 35 in an annular shape in the circumferential direction of the piston main body 35. The passage groove 40 is formed at an end part of the piston main body 35 on the upper chamber 19 side opposite to the passage groove 38 in the axial direction. All the passage holes 39 open to the passage groove 40 at the end part side of the piston main body 35 opposite to the passage groove 38 in the axial direction. End parts of the plurality of passage holes 37 on a side opposite to the passage groove 38 in the axial direction of the piston main body 35 open to an outer side of the passage groove 40 in a radial direction of the piston main body 35. End parts of the plurality of passage holes 39 on a side opposite to the passage groove 40 in the axial direction of the piston main body 35 open to an outer side of the passage groove 38 in the radial direction of the piston main body 35. In the piston 18, the inside of the plurality of passage holes 37 and the inside of the passage groove 38 form a piston-side passage 43. In the piston 18, the inside of the plurality of passage holes 39 and the inside of the passage groove 40 form a piston-side passage 44.

The damping force generation mechanism 33 has a first valve mechanism 41 (valve mechanism) provided in the piston-side passage 43. The first valve mechanism 41 opens and closes the piston-side passage 43 to generate a damping force. The first valve mechanism 41 is disposed on the lower chamber 20 side in the axial direction of the piston 18. Thereby, during the extension stroke, the piston-side passage 43 allows the oil fluid L to flow from the upper chamber 19 on one side toward the lower chamber 20 on the other side via the opened first valve mechanism 41 due to movement of the piston 18 to the upper chamber 19 side which is one direction. The first valve mechanism 41 suppresses a flow of the oil fluid L from the piston-side passage 43 to the lower chamber 20 that occurs at that time, thereby generating a damping force.

The damping force generation mechanism 33 has a first valve mechanism 42 provided in the piston-side passage 44. The first valve mechanism 42 opens and closes the piston-side passage 44 to generate a damping force. The first valve mechanism 42 is disposed on the upper chamber 19 side in the axial direction of the piston 18. Thereby, during the compression stroke, the piston-side passage 44 allows the oil fluid L to flow from the lower chamber 20 toward the upper chamber 19 via the opened first valve mechanism 42 due to movement of the piston 18 to the lower chamber 20 side. The first valve mechanism 42 suppresses a flow of the oil fluid L from the piston-side passage 44 to the upper chamber 19 that occurs at that time, thereby generating a damping force.

The piston main body 35 has a bored disc shape and has an inner circumferential portion to which the mounting shaft portion 28 of the piston rod 21 is fitted.

The piston main body 35 includes a main body portion 50, an inner seat portion 51, a valve seat portion 53, an inner seat portion 55, and a valve seat portion 57. The main body portion 50 is provided at an intermediate part of the piston main body 35 in the axial direction. The inner seat portion 51 and the valve seat portion 53 are provided at an end part of the piston main body 35 on the lower chamber 20 side in the axial direction. The inner seat portion 55 and the valve seat portion 57 are provided at an end part of the piston main body 35 on the upper chamber 19 side in the axial direction.

The inner seat portion 51 has an annular shape. The inner seat portion 51 is provided on an inner circumferential side of the main body portion 50 and protrudes from the main body portion 50 to the lower chamber 20 side in the axial direction of the piston main body 35.

The valve seat portion 53 has an annular shape. The valve seat portion 53 is disposed on an outer side of the inner seat portion 51 in the radial direction of the piston main body 35. The valve seat portion 53 protrudes from the main body portion 50 to the lower chamber 20 side in the axial direction of the piston main body 35. A distal end surface on a protruding side of the valve seat portion 53 is higher in a protruding direction in the axial direction of the piston main body 35 than a distal end surface on a protruding side of the inner seat portion 51. The valve seat portion 53 is disposed outward of the opening of the passage groove 38 on the lower chamber 20 side in the radial direction of the piston main body 35. The valve seat portion 53 constitutes a part of the first valve mechanism 41.

The inner seat portion 55 has an annular shape. The inner seat portion 55 is provided on an inner circumferential side of the main body portion 50 and protrudes from the main body portion 50 to the upper chamber 19 side in the axial direction of the piston main body 35.

The valve seat portion 57 has an annular shape. The valve seat portion 57 is disposed on an outer side of the inner seat portion 55 in the radial direction of the piston main body 35. The valve seat portion 57 protrudes from the main body portion 50 to the upper chamber 19 side in the axial direction of the piston main body 35. A distal end surface on a protruding side of the valve seat portion 57 is higher in the protruding direction in the axial direction of the piston main body 35 than a distal end surface on a protruding side of the inner seat portion 55. The valve seat portion 57 is disposed outward of the opening of the passage groove 40 on the upper chamber 19 side in the radial direction of the piston main body 35. The valve seat portion 57 constitutes a part of the first valve mechanism 42.

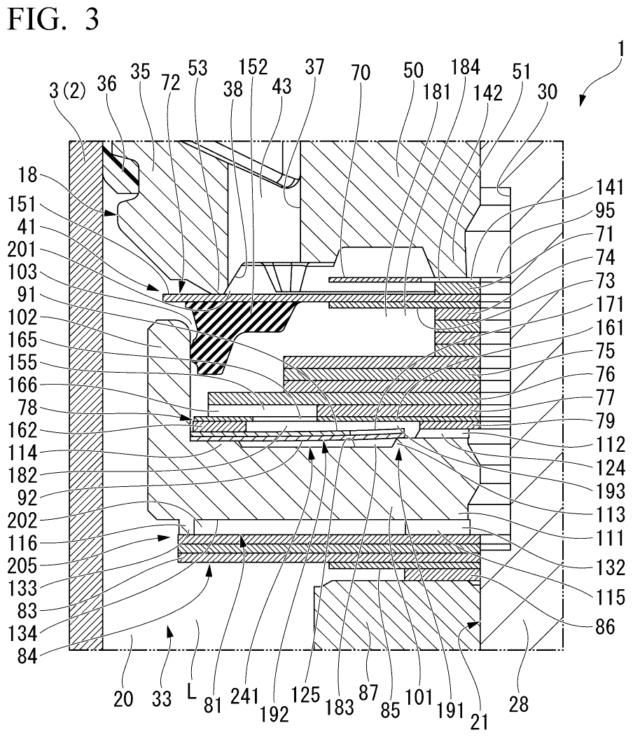

As shown in FIG. 3, the damping force generation mechanism 33 includes a disc 70, one disc 71, one first damping valve 72 (damping force generation member), one disc 73, a plurality of, specifically four, discs 74, a plurality of, specifically three, discs 75, one disc 76, one disc 77, one restriction disc 78 (restriction member), one disc 79, one pilot case 81 (damping force generation member), a second damping valve 84 formed of a plurality of, specifically three, discs 83, one disc 85, one disc 86, and one annular member 87 on the inner seat portion 51 side in the axial direction of the piston 18 in that order from the inner seat portion 51 side in the axial direction of the piston 18.

Also, the damping force generation mechanism 33 has one disc 91 and one disc 92 between the restriction disc 78 and the pilot case 81. The discs 91 and 92 are disposed to surround the disc 79 from an outer side in a radial direction of the disc 79. Of the discs 91 and 92, the disc 91 is provided on the restriction disc 78 side, and the disc 92 is provided on a side opposite to the restriction disc 78.

The discs 70, 71, 73 to 77, 79, 83, 85, 86, 91, and 92, the restriction disc 78, the pilot case 81, and the annular member 87 are all made of a metal. The discs 70, 71, 73 to 77, 79, 83, 85, 86, 91, and 92 and the annular member 87 each have a bored circular flat plate shape with a constant thickness. The discs 70, 71, 73 to 77, 79, 83, 85, 86, 91, and 92 are formed by press forming. The first damping valve 72, the restriction disc 78, and the pilot case 81 are all annular in shape. The mounting shaft portion 28 of the piston rod 21 is fitted to an inner side of all the discs 70, 71, 73 to 77, 79, 83, 85, and 86, the first damping valve 72, the restriction disc 78, the pilot case 81, and the annular member 87.

The piston 18, the discs 70, 71, 73 to 77, 79, and 83, the first damping valve 72, the restriction disc 78, and the pilot case 81 cover the passage groove 30 of the piston rod 21, and form a pilot chamber 95 inside the passage groove 30.

The pilot case 81 has a bottomed cylindrical shape. The pilot case 81 is seamlessly and integrally formed as a whole by sintering. The pilot case 81 has a bottom portion 101 and a cylindrical portion 102.

The bottom portion 101 has a bored disc shape, and has an inner circumferential portion to which the mounting shaft portion 28 of the piston rod 21 is fitted. The cylindrical portion 102 has a cylindrical shape and extends from an outer circumferential portion of the bottom portion 101 to one side of the bottom portion 101 in the axial direction. The pilot case 81 has an opening 103 on a side of the cylindrical portion 102 opposite to the bottom portion 101 in the axial direction. In other words, the pilot case 81 has a bottomed cylindrical shape having the opening 103 at one end in the axial direction.

The bottom portion 101 has a bottom main body portion 111, an inner seat portion 112, a valve seat portion 113, an outer seat portion 114, an inner seat portion 115, and an outer seat portion 116.

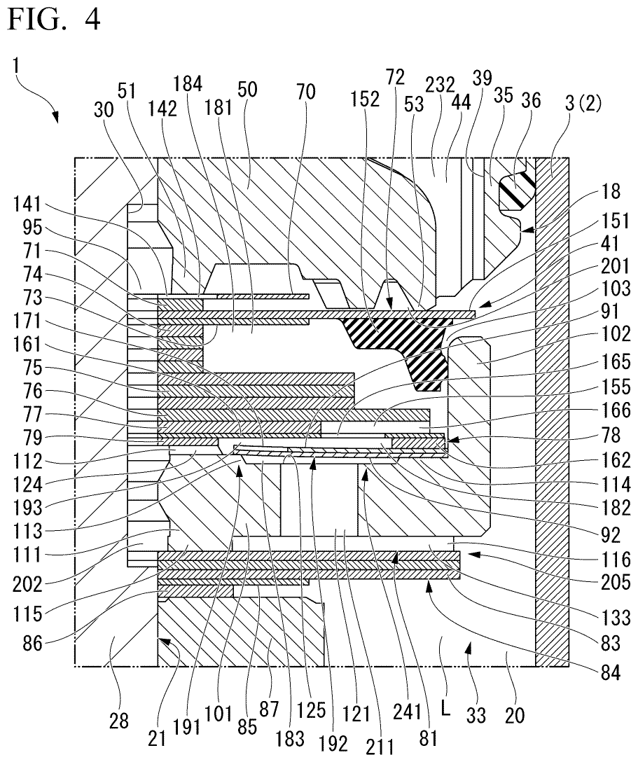

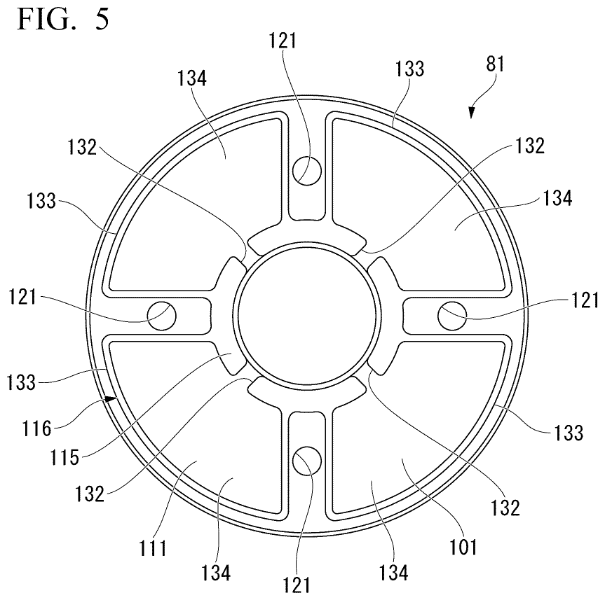

The bottom main body portion 111 has a bored disc shape, and the mounting shaft portion 28 of the piston rod 21 is fitted to an inner circumferential side thereof. As shown in FIG. 4, a passage hole 121 penetrating the bottom main body portion 111 in an axial direction of the bottom main body portion 111 is formed in the bottom main body portion 111. As shown in FIG. 5, a plurality of, specifically four, passage holes 121 are provided in the bottom main body portion 111 at regular intervals in a circumferential direction of the bottom main body portion 111.

As shown in FIGS. 3 and 4, the inner seat portion 112 is formed on an inner circumferential side of the bottom main body portion 111. The inner seat portion 112 has an annular shape. The inner seat portion 112 protrudes from the bottom main body portion 111 to the same side as the cylindrical portion 102 in the axial direction of the bottom main body portion 111. A passage groove 124 penetrating the inner seat portion 112 in a radial direction of the inner seat portion 112 is formed in the inner seat portion 112.

The valve seat portion 113 is formed to be continuous with the inner seat portion 112 on an outer side of the inner seat portion 112 in a radial direction of the bottom main body portion 111. The valve seat portion 113 has an annular shape. The valve seat portion 113 protrudes from the bottom main body portion 111 to the same side as the inner seat portion 112 in the axial direction of the bottom main body portion 111. In an axial direction of the pilot case 81, a height of a distal end surface on a protruding side of the valve seat portion 113 is lower than a height of a distal end surface on a protruding side of the inner seat portion 112 and is equal to a height of a groove bottom surface of the passage groove 124.

The outer seat portion 114 is formed to be continuous with the cylindrical portion 102 on an inner side of the cylindrical portion 102 in the radial direction of the bottom main body portion 111. The outer seat portion 114 is formed to be spaced apart from the valve seat portion 113 on an outer side of the valve seat portion 113 in the radial direction of the bottom main body portion 111. The outer seat portion 114 has an annular shape. The outer seat portion 114 protrudes from the bottom main body portion 111 to the same side as the inner seat portion 112 and the valve seat portion 113 in the axial direction of the bottom main body portion 111. In the axial direction of the pilot case 81, a height of a distal end surface on a protruding side of the outer seat portion 114 is slightly lower than a height of the distal end surface on a protruding side of the valve seat portion 113.

In the bottom portion 101, an annular recessed portion 125 recessed from the cylindrical portion 102 side to a side opposite to the cylindrical portion 102 in the axial direction is formed by the bottom main body portion 111, the valve seat portion 113, and the outer seat portion 114. The annular recessed portion 125 has an annular shape extending in a circumferential direction of the bottom portion 101. The annular recessed portion 125 is recessed from the distal end surface on the protruding side of the valve seat portion 113 and the distal end surface on the protruding side of the outer seat portion 114 to a side opposite to the cylindrical portion 102 in the axial direction of the pilot case 81. A bottom surface of the annular recessed portion 125 is formed by the bottom main body portion 111. The passage hole 121 is formed between the valve seat portion 113 and the outer seat portion 114 in the radial direction of the bottom main body portion 111, and opens to the bottom surface of the annular recessed portion 125.

The inner seat portion 115 is formed on an inner circumferential side of the bottom main body portion 111. The inner seat portion 115 has an annular shape. The inner seat portion 115 protrudes from a portion of the bottom main body portion 111 on an inner circumferential side to a side opposite to the inner seat portion 112 in the axial direction of the bottom main body portion 111. As shown in FIG. 3, a passage groove 132 penetrating the inner seat portion 115 in a radial direction of the inner seat portion 115 is formed in the inner seat portion 115. As shown in FIG. 5, a plurality of, specifically four, passage grooves 132 are provided in the inner seat portion 115 at regular intervals in a circumferential direction of the inner seat portion 115.

The outer seat portion 116 is formed on an outer side of the inner seat portion 115 in the radial direction of the bottom main body portion 111. As shown in FIG. 3, the outer seat portion 116 protrudes, at a radially outward of the inner seat portion 115, from the bottom main body portion 111 to the same side as the inner seat portion 115 in the axial direction of the bottom main body portion 111. As shown in FIG. 5, the outer seat portion 116 is a petal-like non-standard seat that is not circular. The outer seat portion 116 has a plurality of, specifically four, seat constituent portions 133. These seat constituent portions 133 have the same shape and are disposed at regular intervals in a circumferential direction of the pilot case 81. The plurality of seat constituent portions 133 extend radially from the inner seat portion 115. As shown in FIG. 3, in the axial direction of the pilot case 81, positions of distal end surfaces of the plurality of seat constituent portions 133 on a side opposite to the bottom main body portion 111 are at the same position as a position of a distal end surface of the inner seat portion 115 on a side opposite to the bottom main body portion 111.

A passage recessed portion 134 is formed on an inner side of each seat constituent portion 133. As shown in FIG. 5, the passage recessed portion 134 is formed by being surrounded by a part of the inner seat portion 115 and the seat constituent portion 133. As shown in FIG. 3, the passage recessed portion 134 is recessed in the axial direction of the pilot case 81 from a distal end surface on a protruding side of the inner seat portion 115 and a distal end surface on a protruding side of the seat constituent portion 133. A bottom surface of the passage recessed portion 134 is formed by the bottom main body portion 111. As shown in FIG. 5, the passage recessed portion 134 is formed inside each of the seat constituent portions 133. In the circumferential direction of the pilot case 81, the passage recessed portions 134 and the passage grooves 132 of the inner seat portion 115 are respectively in phase with each other. The passage grooves 132 are provided in the inner seat portion 115 to open to the inside of the passage recessed portions 134, respectively.

The passage hole 121 is disposed between adjacent seat constituent portions 133 in the circumferential direction of the pilot case 81. Therefore, the passage hole 121 is disposed outside the outer seat portion 116. The pilot case 81 has four portions that are between adjacent seat constituent parts 133 in the circumferential direction, and the passage hole 121 is provided at each of the four portions.

The disc 70 shown in FIGS. 3 and 4 has a constant outer diameter over the entire circumference. The disc 70 has an outer diameter larger than an outer diameter of the inner seat portion 51 of the piston 18. A notch 141 is formed in the disc 70. The notch 141 extends outward in the radial direction from an inner circumferential edge portion of the disc 70 fitted onto the mounting shaft portion 28. The notch 141 penetrates the disc 70 in an axial direction of the disc 70. The notch 141 of the disc 70, together with the piston 18 and the disc 71, forms an inlet orifice 142.

The disc 71 has a constant outer diameter over the entire circumference, and also has a constant inner diameter over the entire circumference. The disc 71 has an outer diameter smaller than an outer diameter of the disc 70. The disc 71 is provided on an inner side of an outer end position of the notch 141 in a radial direction of the disc 70, and forms the inlet orifice 142 together with the notch 141.

The first damping valve 72 is formed of a disc 151 and a seal member 152.

The disc 151 is made of a metal and has a bored circular flat plate shape with a constant thickness. The disc 151 is formed by press forming. The disc 151 has a constant outer diameter over the entire circumference, and also has a constant inner diameter over the entire circumference. The disc 151 has an outer diameter larger than an outer diameter of the valve seat portion 53 of the piston 18. The mounting shaft portion 28 of the piston rod 21 is fitted to an inner circumferential side of the disc 151. In the first damping valve 72, the disc 151 comes into contact with the valve seat portion 53.

A passage in the inlet orifice 142 of the disc 70 is in constant communication with the piston-side passage 43 and the pilot chamber 95.

When the disc 151 separates from and comes into contact with the valve seat portion 53, the first damping valve 72 opens and closes an opening of the piston-side passage 43 on the lower chamber 20 side which is formed in the piston 18 and shown in FIG. 3.

The seal member 152 is formed of an elastic material having sealing properties and is, specifically, rubber. The seal member 152 has an annular shape. The seal member 152 is fixed to an outer circumferential side of the disc 151. The seal member 152 is fitted to an inner circumferential surface of the cylindrical portion 102 of the pilot case 81 on the opening 103 side over the entire circumference. The seal member 152 is axially slidable with respect to the inner circumferential surface of the cylindrical portion 102. The seal member 152 constantly seals a gap between the first damping valve 72 and the cylindrical portion 102. The pilot case 81 has the opening 103 in which the first damping valve 72 is disposed.

The disc 73 has a constant outer diameter over the entire circumference, and also has a constant inner diameter over the entire circumference. The disc 73 has an outer diameter smaller than a minimum inner diameter of the seal member 152. The disc 73 has an outer diameter equal to the outer diameter of the disc 70.

The disc 74 has a constant outer diameter over the entire circumference, and also has a constant inner diameter over the entire circumference. The disc 74 has an outer diameter smaller than an outer diameter of the disc 73. The disc 74 has an outer diameter equal to the outer diameter of the disc 71.

The disc 75 has a constant outer diameter over the entire circumference, and also has a constant inner diameter over the entire circumference. The disc 75 has an outer diameter larger than the outer diameter of the disc 73 and larger than the outer diameter of the disc 74.

The disc 76 has a constant outer diameter over the entire circumference, and also has a constant inner diameter over the entire circumference. The disc 76 has an outer diameter larger than the outer diameter of the disc 75.

The disc 77 has a constant inner diameter over the entire circumference. The disc 77 has an outer diameter equal to the outer diameter of the disc 76. A notch 155 is formed in the disc 77. The notch 155 extends inward in the radial direction from an outer circumferential edge portion of the disc 77. The notch 155 penetrates the disc 77 in an axial direction of the disc 77. The notch 155 has an inner portion in a radial direction of the disc 77 having an arc shape extending long in a circumferential direction of the disc 77, and the inner portion in the radial direction of the disc 77 is longer in the circumferential direction of the disc 77 than an outer portion of the notch 155 in the radial direction of the disc 77. A plurality of notches 155 are provided in the disc 77 at regular intervals in the circumferential direction of the disc 77.

The restriction disc 78 includes a disc 161 on the disc 77 side and a disc 162 on a side opposite to the disc 77 in an axial direction of the restriction disc 78. The discs 161 and 162 are both made of a metal and have a bored circular flat plate shape with a constant thickness. Both the disc 161 and the disc 162 are formed by press forming.

The disc 161 has a constant outer diameter over the entire circumference, and also has a constant inner diameter over the entire circumference. The disc 161 has an outer diameter larger than the outer diameters of the discs 76 and 77 and smaller than an inner diameter of the cylindrical portion 102 of the pilot case 81. The mounting shaft portion 28 of the piston rod 21 is fitted to an inner circumferential side of the disc 161. A through hole 165 penetrating the disc 161 in an axial direction of the disc 161 is formed in the disc 161. The through hole 165 has an arc shape extending long in a circumferential direction of the disc 161. The through hole 165 is aligned in position in the radial direction of the discs 77 and 161 with an inner portion of the notch 155 of the disc 77 in the radial direction of the disc 77 which has an arc shape extending long in the circumferential direction of the disc 77. A plurality of through holes 165 are provided in the disc 161 at regular intervals in the circumferential direction of the disc 161. A passage in the through hole 165 communicates with a passage in the notch 155 of the disc 77. The notch 155 of the disc 77 and the through hole 165 of the disc 161 constitute a communication orifice 166 (second throttle mechanism).

The disc 162 has a constant outer diameter over the entire circumference, and also has a constant inner diameter over the entire circumference. The disc 162 has an outer diameter slightly larger than the outer diameter of the disc 161 and is smaller than the inner diameter of the cylindrical portion 102 of the pilot case 81. The disc 162 has an inner diameter larger than an inner diameter of the disc 161 and larger than an outer diameter of the valve seat portion 113 of the pilot case 81. The disc 162 is disposed coaxially with the disc 161 and is disposed on an outer side of the through hole 165 in a radial direction of the disc 161. The disc 162 is integrated with the disc 161 by being ring-welded to the disc 161.

The disc 79 has a constant outer diameter over the entire circumference, and also has a constant inner diameter over the entire circumference. The disc 79 has an outer diameter smaller than the inner diameter of the disc 162 of the restriction disc 78. The disc 79 is disposed inward of the through hole 165 in a radial direction of the restriction disc 78. The disc 79 has an outer diameter equal to an outer diameter of the inner seat portion 112 of the pilot case 81.

The disc 83 has a constant outer diameter over the entire circumference, and also has a constant inner diameter over the entire circumference. The disc 83 has an outer diameter equal to an outer diameter of the outer seat portion 116 of the pilot case 81.

The disc 85 has a constant outer diameter over the entire circumference, and also has a constant inner diameter over the entire circumference. The disc 85 has an outer diameter smaller than the outer diameter of the disc 83.

The disc 86 has a constant outer diameter over the entire circumference, and also has a constant inner diameter over the entire circumference. The disc 86 has an outer diameter smaller than the outer diameter of the disc 85. The disc 86 has an outer diameter equal to an outer diameter of the inner seat portion 115 of the pilot case 81.

The annular member 87 has a constant outer diameter over the entire circumference, and also has a constant inner diameter over the entire circumference. The annular member 87 has an outer diameter larger than the outer diameter of the disc 85 and smaller than the outer diameter of the disc 83. The annular member 87 has a larger thickness than the discs 83 and 85 and has a higher rigidity than the disc 83.

The disc 91 has a constant outer diameter over the entire circumference. The disc 91 has an outer diameter slightly larger than the outer diameter of the disc 162 of the restriction disc 78 and slightly smaller than the inner diameter of the cylindrical portion 102 of the pilot case 81. The disc 91 has an inner diameter smaller than the outer diameter of the valve seat portion 113 of the pilot case 81 and larger than the outer diameter of the inner seat portion 112 of the valve seat portion 113 and the disc 79. The disc 91 has a notch 171 formed on an inner circumferential side. The notch 171 extends outward in the radial direction from an inner circumferential edge portion of the disc 91. The notch 171 penetrates the disc 91 in an axial direction of the disc 91.

The disc 92 has a constant outer diameter over the entire circumference, and also has a constant inner diameter over the entire circumference. The disc 92 has an outer diameter equal to the outer diameter of the disc 91 and an inner diameter equal to the inner diameter of the disc 91. The disc 92 has an outer diameter larger than an inner diameter of the outer seat portion 114 of the pilot case 81.

The restriction disc 78 presses an outer circumferential side of the discs 91 and 92 against the outer seat portion 114 of the pilot case 81. At that time, the disc 162 of the restriction disc 78 comes into contact with the outer circumferential side of the disc 91, and the outer circumferential side of the disc 92 comes into contact with the outer seat portion 114. The restriction disc 78, together with the discs 75 to 77, restricts the outer circumferential side of the discs 91 and 92 being separated, that is, opened, from the outer seat portion 114 of the pilot case 81.

As described above, in the axial direction of the pilot case 81, a height in a protruding direction of the outer seat portion 114 is lower than that of the valve seat portion 113. Therefore, the discs 91 and 92, in a state of being pressed against the outer seat portion 114 by the restriction disc 78, are elastically deformed in the axial direction so that an inner circumferential side thereof is positioned closer to the disc 161 side of the restriction disc 78 than an outer circumferential side, resulting in the inner circumferential side being pressed against the valve seat portion 113. At that time, the disc 92 comes into contact with the valve seat portion 113 over the entire circumference.

A portion surrounded by the first damping valve 72, the discs 73 to 77, the restriction disc 78, and the pilot case 81 forms as a main-back pressure chamber 181. A region surrounded by the restriction disc 78 and the discs 91 and 92 forms a sub-back pressure chamber 182. The through hole 165 opens into the sub-back pressure chamber 182. A portion surrounded by the annular recessed portion 125 of the pilot case 81 and the disc 92 forms a variable chamber 183.

The communication orifice 166 formed of the notch 155 of the disc 77 and the through hole 165 of the disc 161 is provided between the main-back pressure chamber 181 and the sub-back pressure chamber 182. In other words, the sub-back pressure chamber 182 is connected to the main-back pressure chamber 181 through a passage in the communication orifice 166.

As shown in FIG. 4, the variable chamber 183 communicates with the lower chamber 20 via a passage in the passage hole 121 of the pilot case 81. A volume of the variable chamber 183 can be changed by deformation of the discs 91 and 92. That is, when the discs 91 and 92 deform to approach a bottom surface of the annular recessed portion 125, the volume of the variable chamber 183 decreases, thereby increasing a volume of the sub-back pressure chamber 182. When the discs 91 and 92 are deformed from this state so that they are separated from the bottom surface of the annular recessed portion 125, the volume of the variable chamber 183 increases, thereby reducing the volume of the sub-back pressure chamber 182.

The main-back pressure chamber 181, the communication orifice 166, and the sub-back pressure chamber 182 constitute a back pressure chamber 184. The bottomed cylindrical pilot case 81 forms the back pressure chamber 184 together with the first damping valve 72 disposed on the opening 103 side.

In a state in which a pressure in the sub-back pressure chamber 182 is equal to or higher than a pressure in the variable chamber 183, the disc 92 of the discs 91 and 92 comes into contact with the valve seat portion 113 over the entire circumference. Thereby, the discs 91 and 92 and the valve seat portion 113 restrict a flow of the oil fluid L from the pilot chamber 95 and the sub-back pressure chamber 182 to the variable chamber 183. In a state in which a pressure in the variable chamber 183 is higher than a pressure in the sub-back pressure chamber 182, the discs 91 and 92 are separated from the valve seat portion 113. Thereby, the discs 91 and 92 and the valve seat portion 113 allow a flow of the oil fluid L from the variable chamber 183 to the pilot chamber 95 and the sub-back pressure chamber 182. Therefore, the discs 91 and 92 and the valve seat portion 113 constitute a check valve 191 that restricts the flow of the oil fluid L from the pilot chamber 95 and the sub-back pressure chamber 182 to the variable chamber 183 while allowing the flow of the oil fluid L from the variable chamber 183 to the pilot chamber 95 and the sub-back pressure chamber 182.

The discs 91 and 92 deform and move in a substantially integrated manner while remaining overlapped. The discs 91 and 92 constitute a movable valve 192 (movable member) of the check valve 191. The valve 192 is provided in the bottom portion 101 of the pilot case 81, defines the variable chamber 183 on a side opposite to the back pressure chamber 184, and blocks the flow of the oil fluid L from the back pressure chamber 184 to the variable chamber 183.

When the check valve 191 opens, a portion of the deforming valve 192 on the inner circumferential side approaches the disc 161 of the restriction disc 78 and reduces a flow path between the portion and the disc 161. The portion of the valve 192 on the inner circumferential side and the disc 161 of the restriction disc 78 constitute a variable orifice 193 (first throttle mechanism, first throttle portion). The variable orifice 193 has a flow path cross-sectional area smaller than a flow path cross-sectional area of the communication orifice 166. The variable orifice 193 is provided between the pilot chamber 95 and the sub-back pressure chamber 182, and changes a cross-sectional area of a flow path between the pilot chamber 95 and the sub-back pressure chamber 182 according to an amount of deformation of the valve 192. That is, the variable orifice 193 reduces the flow path between the pilot chamber 95 and the sub-back pressure chamber 182 as the amount of deformation of the valve 192 increases. The variable orifice 193 has a passage in the notch 171 of the disc 91. The passage in the notch 171 of the disc 91 sets the flow path cross-sectional area inside the variable orifice 193 to a non-zero minimum value when the disc 91 of the valve 192 comes into contact with the disc 161 of the restriction disc 78. In this manner, the valve 192 constitutes the variable orifice 193 that restricts an inflow of the oil fluid L from the variable chamber 183 to the sub-back pressure chamber 182. The valve 192 also serves as the check valve 191. The sub-back pressure chamber 182 is provided between the variable orifice 193 and the main-back pressure chamber 181.

The disc 151 of the first damping valve 72 is seated on the valve seat portion 53 of the piston 18. When the first damping valve 72 is separated from the valve seat portion 53 of the piston 18, the oil fluid L is allowed to flow from the upper chamber 19 to the lower chamber 20 through the piston-side passage 43 shown in FIG. 3 and a passage between the disc 151 and the valve seat portion 53. The piston-side passage 43 and the passage between the disc 151 and the valve seat portion 53 form a first passage 201 that allows communication between the upper chamber 19 and the lower chamber 20 shown in FIG. 2. The first damping valve 72 is provided in the first passage 201 and suppresses a flow of the oil fluid L caused by sliding of the piston 18 to the extension side, thereby generating a damping force. The first damping valve 72, together with the valve seat portion 53 of the piston 18, constitutes the first valve mechanism 41. The first valve mechanism 41 operates to open when the upper chamber 19 is at an upstream pressure, thereby acting to restrict a flow of the oil fluid L. The first passage 201 serves as an extension-side passage through which the oil fluid L flows as a working fluid from the upper chamber 19 on one side to the lower chamber 20 on the other side during movement of the piston 18 to the upper chamber 19 side, that is, during the extension stroke. The first valve mechanism 41 on the extension side, which is formed of the valve seat portion 53 and the first damping valve 72, is provided in the first passage 201, and opens and closes the first passage 201 with the first damping valve 72 to suppress a flow of the oil fluid L, thereby generating a damping force. The first valve mechanism 41 is capable of adjusting the damping force by a pressure in the main-back pressure chamber 181 of the back pressure chamber 184. The lower chamber 20 is on a downstream side of the first damping valve 72 in a direction in which the oil fluid L flows in the first passage 201 during the extension stroke.

As shown in FIG. 3, the second damping valve 84 formed of the plurality of discs 83 has an outer diameter slightly larger than a maximum outer diameter of a distal end surface of the outer seat portion 116. The second damping valve 84 can be separated from and seated on the outer seat portion 116.

The piston-side passage 43, the passage in the inlet orifice 142 of the disc 70, the pilot chamber 95 on the piston rod 21 side, the passage in the variable orifice 193, the back pressure chamber 184, and the passage between the second damping valve 84 and the outer seat portion 116 during the valve opening constitute a second passage 202 that allows communication between the upper chamber 19 and the lower chamber 20 shown in FIG. 2.

A portion of the second passage 202 excluding the piston-side passage 43 shared with the first passage 201 is provided parallel to the first passage 201, thereby allowing communication between the upper chamber 19 and the lower chamber 20. The inlet orifice 142, the pilot chamber 95, the variable orifice 193, the sub-back pressure chamber 182, the communication orifice 166, and the main-back pressure chamber 181 shown in FIG. 3 are provided in the second passage 202.

The outer seat portion 116 and the second damping valve 84 are provided in the second passage 202 and constitute a second valve mechanism 205 that opens and closes the second passage 202. The second damping valve 84 of the second valve mechanism 205 is seated on the outer seat portion 116. The second damping valve 84 opens to provide resistance to a flow of the oil fluid L from the upper chamber 19 to the lower chamber 20 through the second passage 202 during the extension stroke. In other words, the second valve mechanism 205 suppresses the flow of the oil fluid L from the upper chamber 19 to the lower chamber 20, thereby generating a damping force. The second valve mechanism 205 is an extension-side damping force generation mechanism that is provided in the second passage 202 and generates a damping force due to the flow of the oil fluid L.

The back pressure chamber 184 causes an internal pressure to act on the first damping valve 72 in a direction of the piston 18, that is, in a valve closing direction in which the disc 151 is seated on the valve seat portion 53. The pilot case 81 has a bottomed cylindrical shape and forms the back pressure chamber 184 that generates a biasing force in a valve closing direction on the first damping valve 72 disposed on the opening 103 side. In other words, the back pressure chamber 184 generates a biasing force in the valve closing direction on the first damping valve 72, causing it to come into contact with the valve seat portion 53 of the piston 18.

As shown in FIG. 4, the inside of the passage hole 121 provided in the bottom portion 101 of the pilot case 81 constitutes a lower chamber communication passage 211 that allows communication between the variable chamber 183 and the lower chamber 20. When a volume of the variable chamber 183 is reduced by the valve 192, the lower chamber communication passage 211 discharges the oil fluid L of the variable chamber 183 to the lower chamber 20. The variable chamber 183 and the lower chamber communication passage 211 also constitute the second passage 202.

The valve 192 of the check valve 191 is provided to be openable and closable between the lower chamber communication passage 211 and the variable chamber 183, and the back pressure chamber 184 and the pilot chamber 95. In a state in which the valve 192 of the check valve 191 is in contact with the valve seat portion 113 of the pilot case 81, the valve 192 blocks a flow of the oil fluid L between the back pressure chamber 184 and the pilot chamber 95, and the variable chamber 183, the lower chamber communication passage 211, and the lower chamber 20. Also, in a state in which the valve 192 of the check valve 191 is separated from the valve seat portion 113, the valve 192 allows a flow of the oil fluid L between the lower chamber 20, the lower chamber communication passage 211, and the variable chamber 183, and the back pressure chamber 184 and the pilot chamber 95.

Here, when a pressure on a side of the variable chamber 183, the lower chamber communication passage 211, and the lower chamber 20 becomes higher than a pressure on a side of the back pressure chamber 184 and the pilot chamber 95 by a predetermined value or more, the valve 192 of the check valve 191 allows a flow of the oil fluid L from the lower chamber 20 to the back pressure chamber 184 and the pilot chamber 95 via the lower chamber communication passage 211 and the variable chamber 183. When the pressure on a side of the back pressure chamber 184 and the pilot chamber 95 is equal to or higher than the pressure on a side of the variable chamber 183, the lower chamber communication passage 211, and the lower chamber 20, the valve 192 of the check valve 191 restricts a flow of the oil fluid L from the back pressure chamber 184 and the pilot chamber 95 to the lower chamber 20 via the variable chamber 183 and the lower chamber communication passage 211. In other words, the check valve 191 restricts the flow of the oil fluid L in one direction from the back pressure chamber 184 and pilot chamber 95 side to the lower chamber 20 side between the back pressure chamber 184 and pilot chamber 95 and the lower chamber 20. On the other hand, the check valve 191 allows the flow of the oil fluid L in the other direction from the lower chamber 20 side to the back pressure chamber 184 and pilot chamber 95 side. The valve 192 of the check valve 191 is a valve member of the check valve 191.

The check valve 191 restricts a flow of the oil fluid L from the upper chamber 19 and the piston-side passage 43 shown in FIG. 2, and the passage in the inlet orifice 142 of the disc 70, the pilot chamber 95, and the back pressure chamber 184 shown in FIG. 3 to the variable chamber 183, the lower chamber communication passage 211, and the lower chamber 20 shown in FIG. 4. The check valve 191 allows a flow of the oil fluid L from the lower chamber 20, the lower chamber communication passage 211, and the variable chamber 183 to the upper chamber 19 via the back pressure chamber 184, the pilot chamber 95, the passage in the inlet orifice 142 of the disc 70, and the piston-side passage 43 shown in FIG. 2.

The first valve mechanism 42 on the compression side includes one disc 221, one disc 222, a plurality of, specifically three, discs 223, one disc 224, one disc 225, and one annular member 226 on the inner seat portion 55 side in the axial direction of the piston 18 in that order from the inner seat portion 55 side in the axial direction of the piston 18. The discs 221 to 225 and the annular member 226 are made of a metal and has a bored circular flat plate shape with a constant thickness. The discs 221 to 225 are formed by press forming. The mounting shaft portion 28 of the piston rod 21 is fitted to an inner side of all the discs 221 to 225 and the annular member 226.

The disc 221 has an outer diameter equal to an outer diameter of the inner seat portion 55 of the piston 18.

The disc 222 has an outer diameter slightly larger than an outer diameter of the disc 221.

The plurality of discs 223 constitute a first damping valve 231. The first damping valve 231 has an outer diameter slightly larger than an outer diameter of the valve seat portion 57 of the piston 18.

The disc 224 has an outer diameter smaller than an outer diameter of the plurality of discs 223 and equal to the outer diameter of the disc 221.

The disc 225 has an outer diameter larger than the outer diameter of the disc 224.

The annular member 226 has an outer diameter larger than the outer diameter of the disc 225 and smaller than the outer diameter of the disc 223. The annular member 226 has a larger thickness and a higher rigidity than the disc 223. The annular member 226 is in contact with the shaft step portion 29 of the piston rod 21.

The disc 225 and the annular member 226 suppress deformation of the first damping valve 231 in an opening direction beyond a specified limit.

The first damping valve 231 formed of the plurality of discs 223, together with the valve seat portion 57 of the piston 18, constitutes the first valve mechanism 42. The first damping valve 231 opens by being separated from the valve seat portion 57. Then, the first damping valve 231 allows the oil fluid L from the piston-side passage 44 to flow into the upper chamber 19 through a gap between itself and the valve seat portion 57. The piston-side passage 44 and the passage between the first damping valve 231 and the valve seat portion 57 form a compression-side first passage 232 through which the oil fluid L in the lower chamber 20 flows due to movement of the piston 18 to the lower chamber 20 side. During the compression stroke, the first passage 232 allows the oil fluid L as a working fluid to flow from the lower chamber 20 on one side to the upper chamber 19 on the other side. The compression-side first valve mechanism 42 formed of the valve seat portion 57 and the first damping valve 231 is provided in the first passage 232. The first valve mechanism 42 opens and closes the first passage 232 with the first damping valve 231 to suppress a flow of the oil fluid L, thereby generating a damping force.

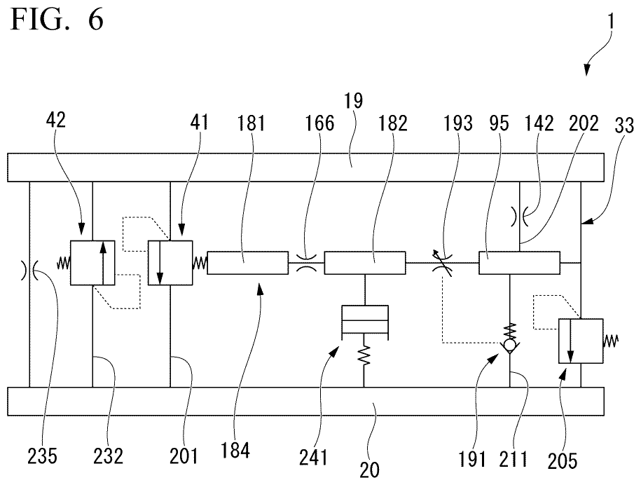

Further, as shown in FIG. 6, a fixed orifice 235 is provided in the shock absorber 1. The fixed orifice 235 allows constant communication between the upper chamber 19 and the lower chamber 20 via the piston 18 shown in FIG. 2. The fixed orifice 235 is formed by, for example, notching at least one of the valve seat portion 57 and the first damping valve 231 of the compression-side first valve mechanism 42. Further, the fixed orifice 235 can also be formed by notching the valve seat portion 53 of the extension-side first valve mechanism 41, or it is also possible to combine the fixed orifices for both the extension side and the compression side.

The pilot case 81 and the valve 192 shown in FIG. 4 constitute a frequency sensitive mechanism 241 that makes a damping force variable in response to a frequency of reciprocation of the piston 18 (hereinafter referred to as a piston frequency). The frequency sensitive mechanism 241 is constituted by a portion of the sub-back pressure chamber 182 that increases when the disc 92 deforms to approach the bottom surface of the annular recessed portion 125, the variable chamber 183, and the valve 192 partitioning them. The frequency sensitive mechanism 241 is an accumulator. The frequency sensitive mechanism 241 is provided in the second passage 202 that includes the lower chamber communication passage 211. In the frequency sensitive mechanism 241, the valve 192 moves and deforms in response to the frequency of reciprocation of the piston 18, thereby changing a volume of the back pressure chamber 184 that is in constant communication with the upper chamber 19 and a volume of the variable chamber 183 that is in constant communication with the lower chamber 20. The frequency sensitive mechanism 241 has the valve 192 that is movably provided in the second passage 202 including the lower chamber communication passage 211. The frequency sensitive mechanism 241 varies the biasing force applied to the first damping valve 72 by the back pressure chamber 184.

During the extension stroke, the sub-back pressure chamber 182 side of the back pressure chamber 184 has a higher pressure than a side of the variable chamber 183, the lower chamber communication passage 211, and the lower chamber 20. Then, the valve 192, receiving the pressure of the sub-back pressure chamber 182, deforms to the bottom surface side of the annular recessed portion 125. Thereby, a volume of the back pressure chamber 184 increases, and a volume of the variable chamber 183 decreases. In this way, the frequency sensitive mechanism 241 operates when the upper chamber 19 is at an upstream pressure, and acts to vary the damping force in response to the piston frequency. In other words, the frequency sensitive mechanism 241 changes the volume of the variable chamber 183 due to movement of the valve 192 caused by the deformation during the extension stroke, thereby changing the volume of the back pressure chamber 184 as a result.

During the compression stroke, a side of the lower chamber 20, the lower chamber communication passage 211, and the variable chamber 183 has a higher pressure than the sub-back pressure chamber 182 side. Then, the valve 192 is separated from the valve seat portion 113 of the pilot case 81, thereby causing the oil fluid L to flow from the lower chamber 20, the lower chamber communication passage 211, and the variable chamber 183 to the sub-back pressure chamber 182 and the pilot chamber 95. In other words, when the lower chamber 20 is at an upstream pressure, the check valve 191, which is provided in the second passage 202 including the lower chamber communication passage 211, operates to open and allow the oil fluid L to flow.

During the compression stroke, when the valve 192 of the check valve 191 is separated from the valve seat portion 113, the valve 192 reduces a flow path cross-sectional area of the passage in the variable orifice 193 between itself and the disc 161 of the restriction disc 78. This acts to restrict a flow of the oil fluid L from the lower chamber 20 to the sub-back pressure chamber 182 via the lower chamber communication passage 211, the variable chamber 183, and the check valve 191 in an open state. As a result, an increase in pressure of the sub-back pressure chamber 182 is suppressed. Also, at that time, since the communication orifice 166 is also provided between the sub-back pressure chamber 182 and the main-back pressure chamber 181, the communication orifice 166 acts to suppress a flow of the oil fluid L from the sub-back pressure chamber 182 to the main-back pressure chamber 181. As a result, an increase in pressure of the main-back pressure chamber 181 is further suppressed compared to the increase in pressure of the sub-back pressure chamber 182. In this way, when the lower chamber 20 is at an upstream pressure, the variable orifice 193 provided downstream of the check valve 191 operates to suppress and control a flow of the oil fluid L, serving as a working fluid, to the sub-back pressure chamber 182 and the main-back pressure chamber 181.

In the piston rod 21, the annular member 226, the disc 225, the disc 224, the plurality of discs 223, the disc 222, the disc 221, and the piston 18 shown in FIG. 2, and the disc 70, the disc 71, the first damping valve 72, the disc 73, the plurality of discs 74, the plurality of discs 75, the disc 76, the disc 77, the restriction disc 78, and the disc 79 shown in FIG. 3 are stacked in that order on the shaft step portion 29 with the mounting shaft portion 28 inserted through the inside of them. Also, the discs 91 and 92 are stacked on the restriction disc 78 in that order. In this state, the pilot case 81, the plurality of discs 83, the disc 85, the disc 86, and the annular member 87 are stacked in that order on the disc 79 with the mounting shaft portion 28 inserted through the inside of them.

With the parts from the annular member 226 to the annular member 87 stacked as described above, as shown in FIG. 2, a nut 245 is screwed onto the male screw 31 of the mounting shaft portion 28 of the piston rod 21 that protrudes from the annular member 87. Thereby, the parts from the annular member 226 to the annular member 87, except for the discs 91 and 92 shown in FIGS. 3 and 4, are clamped in the axial direction by being sandwiched by the shaft step portion 29 of the piston rod 21 shown in FIG. 2 and the nut 245 at the inner circumferential side of them or in their entirety.

In this state, as shown in FIGS. 3 and 4, the seal member 152 of the first damping valve 72 is fitted into the cylindrical portion 102 of the pilot case 81, and the discs 73 to 77, and 79, the restriction disc 78, and the discs 91 and 92 are disposed inside the pilot case 81. The restriction disc 78 presses portions on an outer circumferential side of the discs 91 and 92 against the outer seat portion 114 of the pilot case 81 to prevent axial movement, and brings portions on an inner circumferential side of the discs 91 and 92 into contact with the valve seat portion 113 of the pilot case 81. In this state, the discs 91 and 92 are slightly elastically deformed and come into pressure contact with the valve seat portion 113.

As shown in FIG. 1, the above-described base valve 25 is provided between the inner cylinder 3 and the bottom member 12 of the outer cylinder 4. The base valve 25 includes a base valve member 251, a disc valve 252, a disc valve 253, and an attachment pin 254. The base valve 25 is placed on the bottom member 12 at the base valve member 251, and is fitted into the inner cylinder 3 at the base valve member 251. The base valve member 251 partitions the lower chamber 20 and the reservoir chamber 6. The disc valve 252 is provided on a lower side of the base valve member 251, that is, on the reservoir chamber 6 side. The disc valve 253 is provided on an upper side of the base valve member 251, that is, on the lower chamber 20 side. The attachment pin 254 attaches the disc valve 252 and the disc valve 253 to the base valve member 251.

The base valve member 251 has an annular shape, and the attachment pin 254 is inserted through a center thereof in the radial direction. A plurality of passage holes 255 and a plurality of passage holes 256 are formed in the base valve member 251. The plurality of passage holes 255 allow the oil fluid L to flow between the lower chamber 20 and the reservoir chamber 6. The plurality of passage holes 256 are disposed on an outer side of the plurality of passage holes 255 in a radial direction of the base valve member 251. The plurality of passage holes 256 allow the oil fluid L to flow between the lower chamber 20 and the reservoir chamber 6. The disc valve 252 on the reservoir chamber 6 side allows a flow of the oil fluid L from the lower chamber 20 to the reservoir chamber 6 through the passage holes 255. On the other hand, the disc valve 252 suppresses a flow of the oil fluid L from the reservoir chamber 6 to the lower chamber 20 through the passage holes 255. The disc valve 253 allows a flow of the oil fluid L from the reservoir chamber 6 to the lower chamber 20 through the passage holes 256. On the other hand, the disc valve 253 suppresses a flow of the oil fluid L from the lower chamber 20 to the reservoir chamber 6 through the passage holes 256.

The disc valve 252, together with the base valve member 251, forms a damping valve mechanism 257. The damping valve mechanism 257 opens during the compression stroke of the shock absorber 1 to allow the oil fluid L to flow from the lower chamber 20 to the reservoir chamber 6 and generate a damping force. The disc valve 253, together with the base valve member 251, forms a suction valve mechanism 258. The suction valve mechanism 258 opens during the extension stroke of the shock absorber 1 to allow the oil fluid L to flow from the reservoir chamber 6 into the lower chamber 20. Further, the suction valve mechanism 258 performs a function of causing the liquid to flow from the reservoir chamber 6 to the lower chamber 20 substantially without generating a damping force so that a shortage of the liquid caused mainly due to extension of the piston rod 21 from the cylinder 2 is supplemented.

A configuration of the damping force generation mechanism 33 described above is represented in a hydraulic circuit diagram shown in FIG. 6.

The damping force generation mechanism 33 has the fixed orifice 235 that allows constant communication between the upper chamber 19 and the lower chamber 20. The damping force generation mechanism 33 has the first passage 201 that allows communication between the upper chamber 19 and the lower chamber 20, and the first valve mechanism 41 provided in the first passage 201. The damping force generation mechanism 33 has the second passage 202 that allows communication between the upper chamber 19 and the lower chamber 20 in parallel with the first passage 201. The damping force generation mechanism 33 has, in the second passage 202, the inlet orifice 142, the pilot chamber 95 on the lower chamber 20 side of the inlet orifice 142, and the check valve 191 on the lower chamber 20 side of the pilot chamber 95. The damping force generation mechanism 33 has the second valve mechanism 205 provided in the second passage 202 between the pilot chamber 95 and the lower chamber 20. The damping force generation mechanism 33 has, in the second passage 202, the variable orifice 193 communicating with the pilot chamber 95, the sub-back pressure chamber 182 communicating with the variable orifice 193, the communication orifice 166 communicating with the sub-back pressure chamber 182, and the main-back pressure chamber 181 communicating with the communication orifice 166. The damping force generation mechanism 33 has the frequency sensitive mechanism 241 between the sub-back pressure chamber 182 of the second passage 202 and the lower chamber 20. In the damping force generation mechanism 33, the pressure in the main-back pressure chamber 181 is applied to the first valve mechanism 41 as a back pressure. In the damping force generation mechanism 33, the check valve 191 is interlocked with the variable orifice 193. The damping force generation mechanism 33 has the first passage 232 that allows communication between the lower chamber 20 and the upper chamber 19, and the first valve mechanism 42 provided in the first passage 232.

Next, an operation of the shock absorber 1 including the damping force generation mechanism 33 will be described.

### Low-Frequency Minute-Low-Speed Region x1 in Which Piston Frequency is Low, and Piston Speed is Lower Than First Predetermined Value v1 During Extension Stroke

In this low-frequency minute-low-speed region x1, the first valve mechanism 41 and the second valve mechanism 205 do not open. Then, the oil fluid L from the upper chamber 19 flows into the sub-back pressure chamber 182 of the back pressure chamber 184 via the piston-side passage 43, the passage in the inlet orifice 142 of the disc 70, and the pilot chamber 95. Then, the valve 192 of the frequency sensitive mechanism 241 moves to the bottom surface side of the annular recessed portion 125. In the low-frequency minute-low-speed region x1, since the piston frequency is low and the piston 18 makes a large stroke, a large amount of the oil fluid L is introduced from the upper chamber 19 to the back pressure chamber 184 at the beginning of the stroke. Therefore, the valve 192 of the frequency sensitive mechanism 241 moves and deforms to the bottom surface side of the annular recessed portion 125 to near the limit, and thereafter does not readily deform (high spring region). On the other hand, in the low-frequency minute-low-speed region x1, the oil fluid L from the upper chamber 19 flows into the lower chamber 20 via the fixed orifice 235. Therefore, in the Low-frequency minute-low-speed region x1, a damping force having orifice characteristics (in which the damping force is substantially proportional to the square of the piston speed) is generated. For this reason, in the low-frequency minute-low-speed region x1, an increasing rate of the damping force with respect to an increase in the piston speed is relatively high.

### Low-Frequency Low-Speed Region x2 in Which Piston Frequency is Low, and Piston Speed is Equal to or Higher Than First Predetermined Value v1 and Lower Than Second Predetermined Value v2 During Extension Stroke

In this low-frequency low-speed region x2, the oil fluid L from the upper chamber 19 flows into the upper chamber 19 through the fixed orifice 235 as in the low-frequency minute-low-speed region x1, and largely moves and deforms the valve 192 of the frequency sensitive mechanism 241 to the bottom surface side of the annular recessed portion 125. Thereafter, the oil fluid L from the upper chamber 19 via the piston-side passage 43, the passage in the inlet orifice 142 of the disc 70, and the pilot chamber 95 becomes less likely to be introduced into the back pressure chamber 184. In the low-frequency low-speed region x2, a pressure in the back pressure chamber 184 is higher than that in the low-frequency minute-low-speed region x1. Therefore, in the low-frequency low-speed region x2, the oil fluid L from the upper chamber 19 flows into the lower chamber 20 through the piston-side passage 43, the passage in the inlet orifice 142 of the disc 70, and the pilot chamber 95 by opening the second damping valve 84 of the second valve mechanism 205. That is, the oil fluid L from the upper chamber 19 flows into the lower chamber 20 through the second passage 202. As a result, in the low-frequency low-speed region x2, a damping force having valve characteristics (in which the damping force is substantially proportional to the piston speed) is generated. Therefore, in the low-frequency low-speed region x2, an increasing rate of the damping force with respect to the increase in the piston speed is lower than that in the low-frequency minute-low-speed region x1. In the low-frequency low-speed region x2, since the valve 192 of the frequency sensitive mechanism 241 moves and deforms to near its limit, the pressure in the back pressure chamber 184 becomes high. Therefore, the first damping valve 72 of the first valve mechanism 41 is subjected to a large biasing force from the back pressure chamber 184, and thus opening thereof is restricted.

### Low-Frequency Medium-High-Speed Region x3 in Which Piston Frequency is Low, and Piston Speed is Equal to or Higher Than Second Predetermined Value v2 During Extension Stroke

In this low-frequency medium-high-speed region x3, the oil fluid L from the upper chamber 19 flows into the upper chamber 19 through the fixed orifice 235 as in the low-frequency minute-low-speed region x1, and opens the second damping valve 84 of the second valve mechanism 205 to flow into the lower chamber 20 via the piston-side passage 43, the passage in the inlet orifice 142 of the disc 70, and the pilot chamber 95. In this way, in the low-frequency medium-high-speed region x3, since the oil fluid L flows to the lower chamber 20 through the second passage 202, an increase in pressure of the back pressure chamber 184 due to the oil fluid L introduced into the back pressure chamber 184 from the pilot chamber 95 is suppressed. In contrast, since a force in a valve opening direction exerted to the first valve mechanism 41 from the piston-side passage 43 increases, the oil fluid L from the upper chamber 19 passes through the piston-side passage 43 and flows into the lower chamber 20 by opening the first damping valve 72 of the first valve mechanism 41. That is, the oil fluid L from the upper chamber 19 flows into the lower chamber 20 through the first passage 201. As a result, in the low-frequency medium-high-speed region x3, an increasing rate of the damping force with respect to the increase in the piston speed is lower than that in the low-frequency low-speed region x2.

### High-Frequency Minute-Low-Speed Region x4 in Which Piston Frequency is Higher Than Low Frequency Described Above, and Piston Speed is Lower Than Third Predetermined Value v3 During Extension Stroke

In this high-frequency minute-low-speed region x4, the first valve mechanism 41 and the second valve mechanism 205 do not open. Then, the oil fluid L from the upper chamber 19 flows into the upper chamber 19 through the fixed orifice 235 as in the low-frequency minute-low-speed region x1, and flows into the sub-back pressure chamber 182 of the back pressure chamber 184 via the piston-side passage 43, the passage in the inlet orifice 142 of the disc 70, and the pilot chamber 95. Then, the valve 192 of the frequency sensitive mechanism 241 moves and deforms to the bottom surface side of the annular recessed portion 125. In the high-frequency minute-low-speed region x4, the piston frequency is high, and a stroke of the piston 18 is small. Therefore, an amount of the oil fluid L introduced from the upper chamber 19 into the back pressure chamber 184 is less than that in the low-frequency minute-low-speed region x1. Therefore, the valve 192 of the frequency sensitive mechanism 241 is likely to deform without deforming to near the limit (low spring region). As a result, the oil fluid L introduced from the upper chamber 19 to the back pressure chamber 184 can be absorbed by the movement and deformation of the valve 192. Therefore, in the high-frequency minute-low-speed region x4, although an increasing rate of the damping force with respect to the increase in the piston speed is high, the damping force at the same piston speed is lower than that in the low-frequency minute-low-speed region x1, thereby exhibiting soft characteristics.

### High-Frequency Low-Medium-High-Speed Region x5 in Which Piston Frequency is Higher Than Low Frequency Described Above, and Piston Speed Is Equal to or Higher Than Third Predetermined Value v3 During Extension Stroke

In this high-frequency low-medium-high-speed region x5, the oil fluid L from the upper chamber 19 flows into the upper chamber 19 through the fixed orifice 235 as in the high-frequency minute-low-speed region x4, and moves and deforms the valve 192 of the frequency sensitive mechanism 241 to the bottom surface side of the annular recessed portion 125. In the high-frequency low-medium-high-speed region x5, since an amount of the oil fluid L introduced into the back pressure chamber 184 is small, an increase in pressure of the back pressure chamber 184 is suppressed by the deformation of the valve 192. Therefore, the biasing force from the back pressure chamber 184 to the first damping valve 72 of the first valve mechanism 41 is reduced, making it easier for the first damping valve 72 to open. As a result, the oil fluid L from the upper chamber 19 passes through the piston-side passage 43 and flows into the lower chamber 20 by opening the first damping valve 72 of the first valve mechanism 41. That is, the oil fluid L from the upper chamber 19 flows into the lower chamber 20 through the first passage 201. As a result, in the high-frequency low-medium-high-speed region x5, an increasing rate of the damping force with respect to the increase in the piston speed is lower than that in the high-frequency minute-low-speed region x4. Also, in the high-frequency low-medium-high-speed region x5, the damping force at the same piston speed is lower than those in the low-frequency low-speed region x2 and the low-frequency medium-high-speed region x3, thereby exhibiting softer characteristics. In the high-frequency low-medium-high-speed region x5, since an increase in pressure of the back pressure chamber 184 is suppressed, the second valve mechanism 205 remains in a closed state.

### Minute-Low-Speed Region y1 in Which Piston Speed is Lower Than Fourth Predetermined Value v4 During Compression Stroke

In this minute-low-speed region y1, the first valve mechanism 42 and the check valve 191 do not open. Then, the oil fluid L from the lower chamber 20 flows into the upper chamber through the fixed orifice 235. Therefore, in the minute-low-speed region y1, a damping force having orifice characteristics (in which the damping force is substantially proportional to the square of the piston speed) is generated. Therefore, in the minute-low-speed region y1, an increasing rate of the damping force with respect to an increase in the piston speed is relatively high.

### Low-Speed Region y2 in Which Piston Speed is Equal to or Higher Than Fourth Predetermined Value v4 and Lower Than Fifth Predetermined Value v5 During Compression Stroke

In this low-speed region y2, the oil fluid L from the lower chamber 20 flows into the upper chamber 19 through the fixed orifice 235 as in the minute-low-speed region y1. In addition to that, in the low-speed region y2, the oil fluid L from the lower chamber 20 is introduced into the variable chamber 183 through the lower chamber communication passage 211, opens the check valve 191, is introduced into the pilot chamber 95, and flows into the upper chamber 19 via the inlet orifice 142 of the disc 70 and the piston-side passage 43. In the low-speed region y2, an increasing rate of the damping force with respect to the increase in the piston speed is lower than that in the minute-low-speed region y1. At this time, the valve 192 of the opened check valve 191 reduces the passage in the variable orifice 193 to suppress an increase in pressure of the sub-back pressure chamber 182, and the communication orifice 166 further suppresses an increase in pressure of the main-back pressure chamber 181.

### Medium-High-Speed Region y3 in Which Piston Speed is Equal to or Higher Than Fifth Predetermined Value v5 During Compression Stroke

In this medium-high-speed region y3, the oil fluid L from the lower chamber 20 flows into the upper chamber 19 through the fixed orifice 235 as in the low-speed region y2, and flows from the lower chamber communication passage 211 into the upper chamber 19 via the pilot chamber 95, the inlet orifice 142, and the piston-side passage 43 by opening the check valve 191. In the medium-high-speed region y3, in addition to these, the oil fluid L from the lower chamber 20 passes through the piston-side passage 44 and flows into the upper chamber 19 by opening the first damping valve 231 of the first valve mechanism 42. As a result, in the medium-high-speed region y3, an increasing rate of the damping force with respect to the increase in the piston speed is lower than that in the low-speed region y2. Also at this time, the valve 192 of the opened check valve 191 reduces the passage in the variable orifice 193 to suppress an increase in pressure of the sub-back pressure chamber 182, and the communication orifice 166 further suppresses an increase in pressure of the main-back pressure chamber 181.

Here, a diameter of the back pressure chamber 184 is larger than a diameter of the valve seat portion 53 of the piston 18. Therefore, the extension-side first damping valve 72 receives a pressure of the lower chamber 20 during the compression stroke.

When the pressure in the lower chamber 20 increases and reaches a predetermined pressure during the compression stroke, the valve 192 of the check valve 191 provided in the pilot case 81 opens to introduce the pressure into the back pressure chamber 184. Thereby, when a valve-closing force due to the back pressure acts on the first damping valve 72 and exceeds a valve-opening force due to the pressure in the lower chamber 20 acting on an outer circumferential side of the first damping valve 72, opening of the first damping valve 72 is prevented during the compression stroke.

Further, during the compression stroke, the shock absorber 1 has characteristics in which the damping force characteristics due to the damping valve mechanism 257 are also combined.

Patent Document 1 described above discloses a shock absorber having a damping force generation mechanism in which a damping force is variable in response to a frequency. In a shock absorber, it is required that a damping force generation mechanism operate smoothly. For example, in the shock absorber described in Patent Document 1, a free valve that functions as a check valve during the compression stroke and functions as a back pressure introduction valve during the extension stroke is provided. In this case, if the back pressure chamber becomes high in pressure due to opening of the check valve during the compression stroke, when the check valve is closed during a stroke reversal from the compression stroke to the extension stroke, the high back pressure in the back pressure chamber may hinder smooth opening of the damping force generation mechanism, and thereby the damping force may increase. As a result, in a situation in which a soft damping force is to be generated during the stroke reversal from the compression stroke to the extension stroke, it becomes difficult to generate a soft damping force.

The shock absorber 1 of the first embodiment has the first passage 201 through which the oil fluid L serving as a working fluid flows from the upper chamber 19 on one side in the cylinder 2 due to movement of the piston 18, and the second passage 202 provided parallel to the first passage 201. Also, the shock absorber 1 includes the first valve mechanism 41 provided in the first passage 201 and operating during the extension stroke when the upper chamber 19 is at an upstream pressure to allow the damping force to be adjusted by the pressure of the main-back pressure chamber 181, and the frequency sensitive mechanism 241 provided in the second passage 202 and operating when the upper chamber 19 is at an upstream pressure to vary the volume according to the movement of the valve 192. Also, the shock absorber 1 includes the check valve 191 provided in the second passage 202 and operating to allow the oil fluid L to flow when the lower chamber 20 is at an upstream pressure. Then, the shock absorber 1 includes the variable orifice 193 provided downstream of the check valve 191 and operating during the compression stroke when the lower chamber 20 is at an upstream pressure to control a flow of the oil fluid L to the main-back pressure chamber 181. Thereby, even if the check valve 191 is opened during the compression stroke, the flow of the oil fluid L into the main-back pressure chamber 181 can be suppressed by the variable orifice 193, and thereby the main-back pressure chamber 181 becoming a high pressure can be suppressed. Therefore, a back pressure of the main-back pressure chamber 181 hindering smooth opening of the first valve mechanism 41 can be suppressed during the stroke reversal from the compression stroke to the extension stroke. Therefore, the damping force generation mechanism 33 including the first valve mechanism 41 can be operated smoothly. As a result, in a situation in which a soft damping force is to be generated during the stroke reversal from the compression stroke to the extension stroke, it is possible to satisfactorily generate a soft damping force.

Also, since the valve 192 also functions as the check valve 191, the number of parts of the damping force generation mechanism 33 can be reduced, and the shock absorber 1 can be made small in size. Since the number of parts of the damping force generation mechanism 33 can be reduced, reduction in cost and weight of the shock absorber 1 can be achieved.

Also, the shock absorber 1 includes the sub-back pressure chamber 182 provided between the variable orifice 193 and the main-back pressure chamber 181. Therefore, even if the check valve 191 is opened during the compression stroke, the oil fluid L flows from the variable orifice 193 to the sub-back pressure chamber 182, and the oil fluid L flows from the sub-back pressure chamber 182 to the main-back pressure chamber 181. Therefore, the flow of the oil fluid L into the main-back pressure chamber 181 can be further suppressed, and the main-back pressure chamber 181 becoming a high pressure can be further suppressed. As a result, the back pressure of the main-back pressure chamber 181 hindering the smooth opening of the first valve mechanism 41 can be further suppressed during the stroke reversal from the compression stroke to the extension stroke. Therefore, the damping force generation mechanism 33 including the first valve mechanism 41 can be operated even more smoothly.

Also, in the shock absorber 1, the sub-back pressure chamber 182 communicates with the main-back pressure chamber 181 through the communication orifice 166. Therefore, even if the check valve 191 is opened during the compression stroke, the flow of the oil fluid L into the sub-back pressure chamber 182 can be suppressed by the variable orifice 193, and the flow of the oil fluid L from the sub-back pressure chamber 182 to the main-back pressure chamber 181 can be suppressed by the communication orifice 166. Therefore, the main-back pressure chamber 181 becoming a high pressure can be further suppressed. As a result, the back pressure of the main-back pressure chamber 181 hindering the smooth opening of the first valve mechanism 41 can be further suppressed during the stroke reversal from the compression stroke to the extension stroke. Therefore, the damping force generation mechanism 33 including the first valve mechanism 41 can be operated even more smoothly.

The damping force generation mechanism 33 of the first embodiment includes the pilot case 81, the valve 192, and the restriction disc 78. The pilot case 81 has a bottomed cylindrical shape and forms the back pressure chamber 184 that generates a biasing force in a valve closing direction on the first damping valve 72 disposed on the opening 103 side. The valve 192 is provided in the bottom portion 101 of the pilot case 81, defines the variable chamber 183 on a side opposite to the back pressure chamber 184, and blocks the flow of the oil fluid L from the back pressure chamber 184 to the variable chamber 183. The restriction disc 78 comes into contact with an outer circumferential side of the valve 192 to restrict opening of the valve 192. Then, the valve 192 has the variable orifice 193 that restricts an inflow of the oil fluid L from the variable chamber 183 to the back pressure chamber 184. Thereby, even if the valve 192 is opened, the inflow of the oil fluid L from the variable chamber 183 to the back pressure chamber 184 can be restricted by the variable orifice 193, and thereby the back pressure chamber 184 becoming a high pressure can be suppressed. Therefore, the back pressure in the back pressure chamber 184 hindering the smooth opening of the first valve mechanism 41 can be suppressed during the stroke reversal. Therefore, the damping force generation mechanism 33 can operate smoothly.

The shock absorber 1 and the damping force generation mechanism 33 of the first embodiment can be modified as in the following modified examples 1 and 2.

### Modified Example 1

In the shock absorber 1 and the damping force generation mechanism 33 of the first embodiment, the restriction disc 78 is integrated with the disc 161 by welding the disc 162 to the disc 161, but the disc 162 may be integrated with an outer circumferential portion of the disc 91 of the valve 192 on a side opposite to the disc 92 by welding without being welded to the disc 161. In this case, the disc 161 (restriction member) is in contact with the disc 162 that is integrated with the disc 91, and presses the valve 192 including the disc 162 against the outer seat portion 114 of the pilot case 81. That is, in this case, the disc 161 comes into contact with the outer circumferential side of the valve 192 including the disc 162 to restrict opening of the valve 192.

### Modified Example 2

The disc 162 is positioned in the radial direction by the cylindrical portion 102 of the pilot case 81 without being welded to either the disc 161 or the disc 91. In this case, the disc 162 is sandwiched between the disc 161 and the disc 91 in the axial direction, and the disc 162 (restriction member) is in contact with the disc 91 to press the valve 192 against the outer seat portion 114 of the pilot case 81. That is, in this case, the disc 162 comes into contact with the outer circumferential side of the valve 192 to restrict opening of the valve 192.

### Second Embodiment

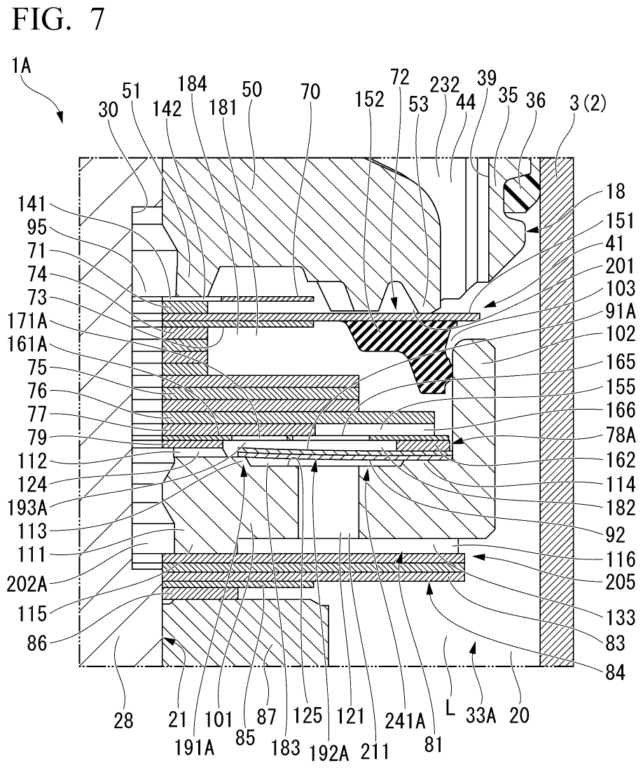

Next, a second embodiment will be described mainly with reference to FIG. 7, focusing on differences from the first embodiment. Further, portions common to those in the first embodiment will be denoted by the same terms and the same reference signs.

As shown in FIG. 7, a shock absorber 1A of the second embodiment includes a damping force generation mechanism 33A that is partially different from the damping force generation mechanism 33 instead of the damping force generation mechanism 33. The damping force generation mechanism 33A includes a restriction disc 78A that is partially different from the restriction disc 78 instead of the restriction disc 78. The restriction disc 78A includes a disc 161A that is partially different from the disc 161 instead of the disc 161.

A slit 171A is formed in the disc 161A on an inner side of a through hole 165 in a radial direction of the disc 161A. The slit 171A penetrates the disc 161A in an axial direction of the disc 161A. The slit 171A has a linear shape extending in a radial direction of the disc 161A. A plurality of slits 171A are formed in the disc 161A at regular intervals in a circumferential direction of the disc 161A. The slit 171A opens into a sub-back pressure chamber 182.

The damping force generation mechanism 33A includes a valve 192A (movable member) that is partially different from the valve 192 instead of the valve 192. The valve 192A includes a disc 91A that is partially different from the disc 91 instead of the disc 91.

The disc 91A does not have the notch 171 formed in the disc 91. The disc 91A has a constant outer diameter over the entire circumference, and also has a constant inner diameter over the entire circumference. The disc 91A is a common part having the same shape as a disc 92.

The damping force generation mechanism 33A has a check valve 191A that is partially different from the check valve 191 instead of the check valve 191. The check valve 191A differs from the check valve 191 in that it has the valve 192A instead of the valve 192. In the check valve 191A, the valve 192A operates in the same manner as the valve 192. Therefore, the check valve 191A operates in the same manner as the check valve 191.

The damping force generation mechanism 33A has a frequency sensitive mechanism 241A that is partially different from the frequency sensitive mechanism 241 instead of the frequency sensitive mechanism 241. The frequency sensitive mechanism 241A differs from the frequency sensitive mechanism 241 in that it includes the valve 192A instead of the valve 192. In the frequency sensitive mechanism 241A, the valve 192A operates in the same manner as the valve 192. Therefore, the frequency sensitive mechanism 241A operates in the same manner as the frequency sensitive mechanism 241.

The damping force generation mechanism 33A has a variable orifice 193A (first throttle mechanism, first throttle portion) that is partially different from the variable orifice 193 instead of the variable orifice 193. When the check valve 191A opens, the variable orifice 193A reduces a flow path between itself and the disc 161A due to a portion of the valve 192A on a circumferential side approaching the disc 161A of the restriction disc 78A. A portion of the valve 192A on an inner circumferential side and the disc 161A of the restriction disc 78A constitute the variable orifice 193A. The variable orifice 193A has a flow path cross-sectional area smaller than a flow path cross-sectional area of a communication orifice 166. The variable orifice 193A is provided between the pilot chamber 95 and the sub-back pressure chamber 182, and changes the flow path between the pilot chamber 95 and the sub-back pressure chamber 182 according to an amount of deformation of the valve 192A. The variable orifice 193A includes the slit 171A of the disc 161A. A passage in the slit 171A of the disc 161A sets the flow path cross-sectional area in the variable orifice 193A to a non-zero minimum value when the disc 91A of the valve 192A comes into contact with the disc 161A of the restriction disc 78A. That is, the slit 171A of the disc 161A performs the same function as the notch 171 of the disc 91. In this manner, the valve 192A constitutes the variable orifice 193A that restricts an inflow of the oil fluid L from a variable chamber 183 to the sub-back pressure chamber 182. The valve 192A also serves as the check valve 191A. A sub-back pressure chamber 182 is provided between the variable orifice 193A and a main-back pressure chamber 181.

The damping force generation mechanism 33A has a second passage 202A that is partially different from the second passage 202 instead of the second passage 202. The second passage 202A differs from the second passage 202 in that it has the variable orifice 193A instead of the variable orifice 193.

In the shock absorber 1A, when the valve 192A of the check valve 191A is separated from the valve seat portion 113 during the compression stroke, the valve 192A reduces a flow path cross-sectional area of a passage in the variable orifice 193A between itself and the disc 161A of the restriction disc 78A. Thereby, a flow of the oil fluid L from the lower chamber 20 to the sub-back pressure chamber 182 via a lower chamber communication passage 211, the variable chamber 183, and the opened check valve 191A is suppressed. As a result, an increase in pressure of the sub-back pressure chamber 182 is suppressed. In this way, when the lower chamber 20 is at an upstream pressure, the variable orifice 193A provided downstream of the check valve 191A operates to suppress and control a flow of the oil fluid L, serving as a working fluid, to the sub-back pressure chamber 182 and the main-back pressure chamber 181.

A hydraulic circuit diagram of the configuration of the damping force generation mechanism 33A described above is similar to that of the damping force generation mechanism 33 of the first embodiment. That is, in FIG. 6, the second passage 202 corresponds to the second passage 202A, the check valve 191 corresponds to the check valve 191A, the variable orifice 193 corresponds to the variable orifice 193A, and the frequency sensitive mechanism 241 corresponds to the frequency sensitive mechanism 241A.

The shock absorber 1A and the damping force generation mechanism 33A of the second embodiment also include the variable orifice 193A that operates in the same manner as the variable orifice 193, and therefore achieve the same effects as the shock absorber 1 and the damping force generation mechanism 33 of the first embodiment.

The shock absorber 1A and the damping force generation mechanism 33A of the second embodiment can be modified as in modified example 1 and modified example 2 of the first embodiment. That is, a disc 162 may be integrated with an outer circumferential portion of the disc 91A of the valve 192A on a side opposite to the disc 92 by welding without being welded to the disc 161A. Alternatively, the disc 162 may be positioned in the radial direction by a cylindrical portion 102 of a pilot case 81 and sandwiched in the axial direction between the disc 161 and the disc 91A without being welded to either the disc 161 or disc 91A.

### Third Embodiment

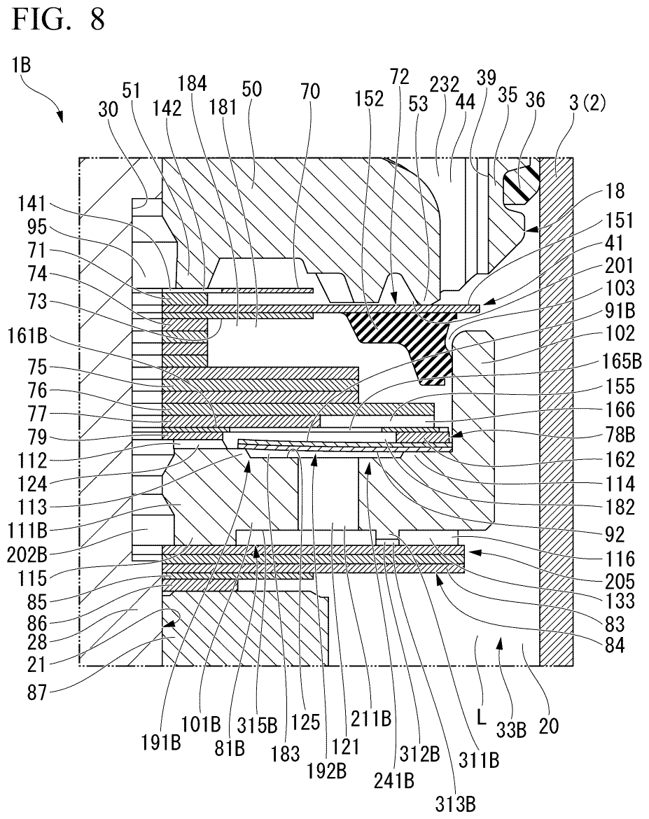

Next, a third embodiment will be described mainly with reference to FIGS. 8 to 10, focusing on differences from the first embodiment. Further, portions common to those in the first embodiment will be denoted by the same terms and the same reference signs.

As shown in FIG. 8, a shock absorber 1B of the third embodiment includes a damping force generation mechanism 33B that is partially different from the damping force generation mechanism 33 instead of the damping force generation mechanism 33. The damping force generation mechanism 33B includes a restriction disc 78B that is partially different from the restriction disc 78 instead of the restriction disc 78. The restriction disc 78B includes a disc 161B that is partially different from the disc 161 instead of the disc 161.

The disc 161B has a through hole 165B that is partially different from the through hole 165 instead of the through hole 165. The through hole 165B penetrates the disc 161B in an axial direction of the disc 161B. In a radial direction of the disc 161B, the through hole 165B extends further inward than the through hole 165. The through hole 165B opens into a sub-back pressure chamber 182. A plurality of through holes 165B are provided in the disc 161B at regular intervals in a circumferential direction of the disc 161B. The through hole 165B, together with a notch 155 of a disc 77, constitutes a communication orifice 166 similar to that in the first embodiment.

The damping force generation mechanism 33B includes a valve 192B (movable member) that is partially different from the valve 192 instead of the valve 192. The valve 192B includes a disc 91B that is partially different from the disc 91 instead of the disc 91.

The disc 91B does not include the notch 171 formed in the disc 91. The disc 91B has a constant outer diameter over the entire circumference, and also has a constant inner diameter over the entire circumference. The disc 91B is a common part having the same shape as a disc 92.

The damping force generation mechanism 33B has a check valve 191B that is partially different from the check valve 191 instead of the check valve 191. The check valve 191B differs from the check valve 191 in that it has the valve 192B instead of the valve 192. In the check valve 191B, the valve 192B operates in the same manner as the valve 192. Therefore, the check valve 191B operates in the same manner as the check valve 191.

The damping force generation mechanism 33B has a frequency sensitive mechanism 241B that is partially different from the frequency sensitive mechanism 241 instead of the frequency sensitive mechanism 241. The frequency sensitive mechanism 241B differs from the frequency sensitive mechanism 241 in that it includes the valve 192B instead of the valve 192. In the frequency sensitive mechanism 241B, the valve 192B operates in the same manner as the valve 192. Therefore, the frequency sensitive mechanism 241B operates in the same manner as the frequency sensitive mechanism 241.

The variable orifice 193 is not provided in the damping force generation mechanism 33B. A passage in the through hole 165B of the disc 161B allows a variable chamber 183 and a pilot chamber 95 to communicate with the sub-back pressure chamber 182 even when the disc 91B of the valve 192B comes into contact with the disc 161B of the restriction disc 78B.

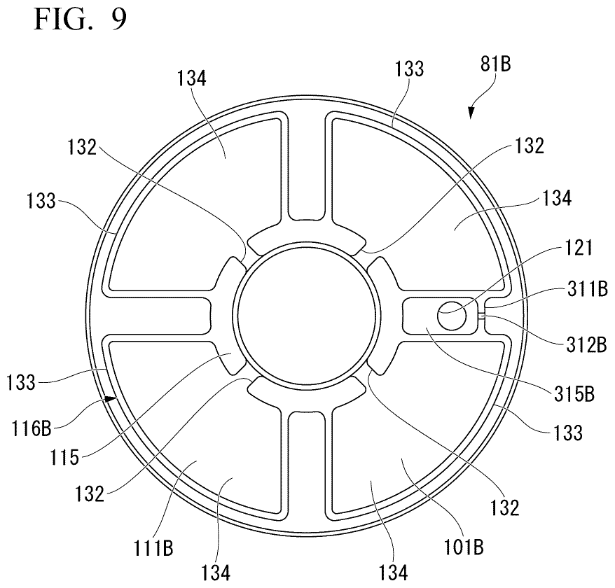

The damping force generation mechanism 33B includes a pilot case 81B that is partially different from the pilot case 81 instead of the pilot case 81. The pilot case 81B has a bottom portion 101B that is partially different from the bottom portion 101 instead of the bottom portion 101. The bottom portion 101B has a bottom main body portion 111B that is partially different from the bottom main body portion 111 instead of the bottom main body portion 111. As shown in FIG. 9, only one passage hole 121 is provided in the bottom main body portion 111B.

The bottom portion 101B has an outer seat portion 116B that is partially different from the outer seat portion 116. The outer seat portion 116B includes a connection seat portion 311B formed to connect seat constituent portions 133 with the passage hole 121 disposed at an intermediate position between them in a circumferential direction of the pilot case 81B. The connection seat portion 311B is disposed outside the passage hole 121 in a radial direction of the pilot case 81B. As shown in FIG. 8, in an axial direction of the pilot case 81B, a distal end surface of the connection seat portion 311B on a side opposite to the bottom main body portion 111B is aligned in position with a distal end surface of an inner seat portion 115 on a side opposite to the bottom main body portion 111B and a distal end surface of the seat constituent portion 133 on a side opposite to the bottom main body portion 111B.

A notch 312B penetrating the connection seat portion 311B in the radial direction of the pilot case 81B is formed in the connection seat portion 311B. The notch 312B is recessed to the bottom main body portion 111B side from the distal end surface of the connection seat portion 311B on a side opposite to the bottom main body portion 111B. The notch 312B is formed in the pilot case 81B by a coining. The notch 312B, together with a disc 83 which is in contact with the outer seat portion 116B, constitutes an orifice 313B.

As shown in FIG. 9, a passage recessed portion 315B is formed by being surrounded by two seat constituent portions 133 disposed on both sides of the passage hole 121 in the circumferential direction of the pilot case 81B, a portion of the inner seat portion 115 between the seat constituent portions 133, and the connection seat portion 311B. As shown in FIG. 8, the passage recessed portion 315B is recessed in an axial direction of the pilot case 81 from the distal end surface on a protruding side of the inner seat portion 115, the distal end surface on a protruding side of the seat constituent portion 133, and the distal end surface of the connection seat portion 311B. A bottom surface of the passage recessed portion 315B is formed by the bottom main body portion 111. The orifice 313B opens to the inside of the passage recessed portion 315B and to a lower chamber 20.

The damping force generation mechanism 33B has a lower chamber communication passage 211B that is partially different from the lower chamber communication passage 211 instead of the lower chamber communication passage 211. The lower chamber communication passage 211B is formed of a passage in the passage recessed portion 315B and a passage in the passage hole 121. The lower chamber communication passage 211B communicates with the lower chamber 20 via the orifice 313B.

The damping force generation mechanism 33B has a second passage 202B that is partially different from the second passage 202 instead of the second passage 202. The second passage 202B differs from the second passage 202 in that it has the lower chamber communication passage 211B instead of the lower chamber communication passage 211, it has the orifice 313B, and the variable orifice 193 is not provided therein.

In the shock absorber 1B, the orifice 313B of the pilot case 81B operates to suppress a flow of the oil fluid L from the lower chamber 20 to the lower chamber communication passage 211B and the variable chamber 183 during the compression stroke. Thereby, a flow of the oil fluid L from the lower chamber 20 to the sub-back pressure chamber 182 via the orifice 313B, the lower chamber communication passage 211B, and the opened check valve 191B is suppressed. As a result, an increase in pressure of the sub-back pressure chamber 182 is suppressed. In this way, when the lower chamber 20 is at an upstream pressure, the orifice 313B provided upstream of the check valve 191B operates to suppress and control a flow of the oil fluid L, serving as a working fluid, to the sub-back pressure chamber 182 and a main-back pressure chamber 181.

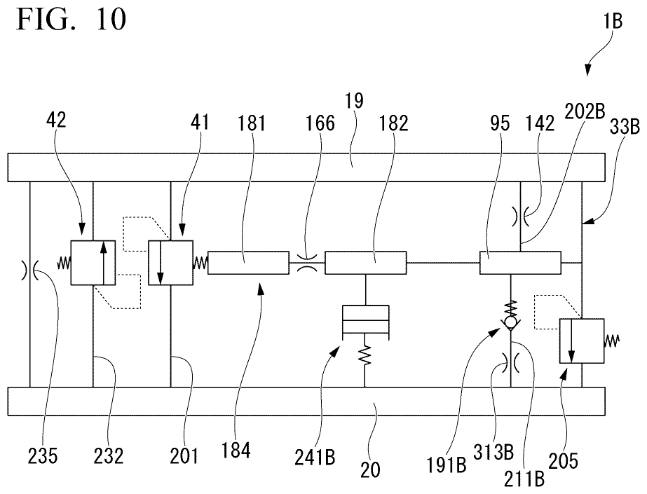

A hydraulic circuit diagram of the configuration of the damping force generation mechanism 33B described above is shown in FIG. 10. That is, the check valve 191 corresponds to the check valve 191B, the frequency sensitive mechanism 241 corresponds to the frequency sensitive mechanism 241B, and the orifice 313B is provided between the lower chamber communication passage 211B and the lower chamber 20. Also, in the damping force generation mechanism 33B, the second passage 202 corresponds to the second passage 202B, and the variable orifice 193 is not provided in the second passage 202B.

The shock absorber 1B of the third embodiment includes the orifice 313B provided upstream of the check valve 191B and operating during the compression stroke when the lower chamber 20 is at an upstream pressure to control a flow of the oil fluid L to the main-back pressure chamber 181. Thereby, even if the check valve 191 is opened during the compression stroke, the flow of the oil fluid L into the main-back pressure chamber 181 can be suppressed by the orifice 313B, and thereby the main-back pressure chamber 181 becoming a high pressure can be suppressed. Therefore, a back pressure of the main-back pressure chamber 181 hindering smooth opening of a first valve mechanism 41 can be suppressed during a stroke reversal from the compression stroke to the extension stroke. Therefore, the damping force generation mechanism 33B including the first valve mechanism 41 can be smoothly operated. As a result, in a situation in which a soft damping force is to be generated during the stroke reversal from the compression stroke to the extension stroke, it is possible to satisfactorily generate a soft damping force.

Also, the shock absorber 1B includes the sub-back pressure chamber 182 provided between the orifice 313B and the main-back pressure chamber 181. Therefore, even if the check valve 191 is opened during the compression stroke, the oil fluid L flows from the orifice 313B to the sub-back pressure chamber 182 and the oil fluid L flows from the sub-back pressure chamber 182 to the main-back pressure chamber 181. Therefore, the flow of the oil fluid L into the main-back pressure chamber 181 can be further suppressed, and thereby the main-back pressure chamber 181 becoming a high pressure can be further suppressed. As a result, the back pressure of the main-back pressure chamber 181 hindering smooth opening of the first valve mechanism 41 can be further suppressed during a stroke reversal from the compression stroke to the extension stroke. Therefore, the damping force generation mechanism 33B including the first valve mechanism 41 can be operated even more smoothly.

The shock absorber 1B and the damping force generation mechanism 33B of the third embodiment can be modified as in the first and second modified examples of the first embodiment. That is, a disc 162 may be integrated with an outer circumferential portion of the disc 91B of the valve 192B on a side opposite to the disc 92 by welding without being welded to the disc 161B. Alternatively, the disc 162 may be positioned in the radial direction by the cylindrical portion 102 of the pilot case 81 and sandwiched in the axial direction between the disc 161 and the disc 91B without being welded to either the disc 161 or disc 91B.

### Other Application Examples of First to Third Embodiments

The configurations of the first to third embodiments can all be applied to a built-in control valve type damping force generation mechanism.

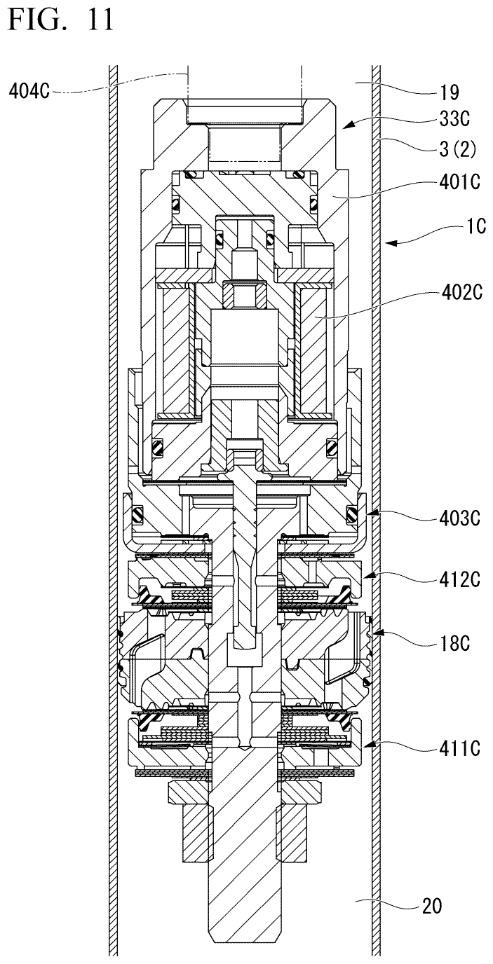

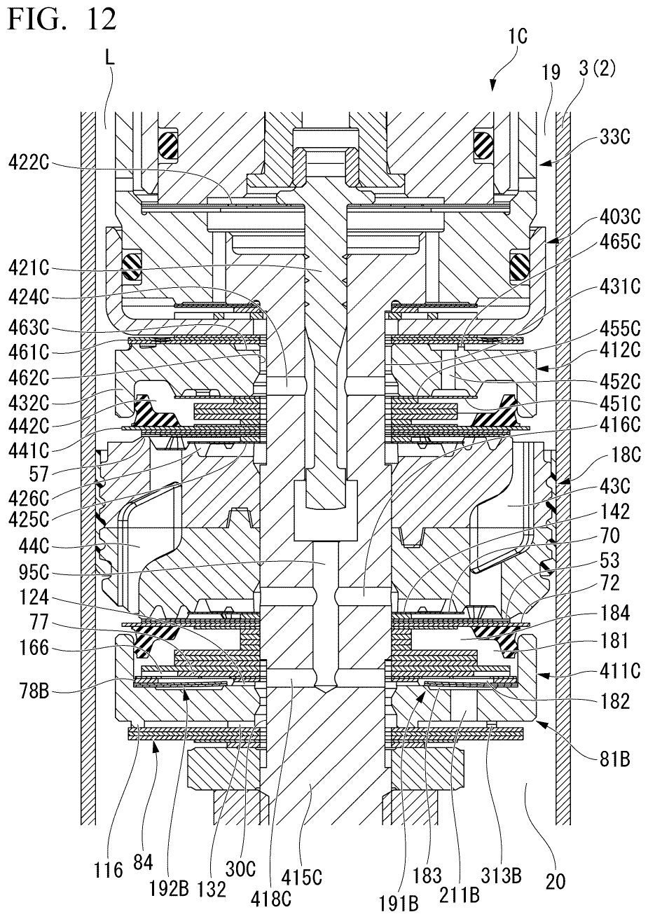

For example, FIGS. 11 and 12 show a shock absorber 1C having a built-in control valve type damping force generation mechanism 33C, and an example in which a main configuration of the damping force generation mechanism 33B of the third embodiment is applied to an extension side of a damping force generation mechanism 33C. In addition, here as well, portions common to those in the third embodiment will be denoted by the same terms and the same reference signs.

As shown in FIG. 11, in the damping force generation mechanism 33C, the inside of the inner cylinder 3 of the cylinder 2 is separated into the upper chamber 19 and the lower chamber 20 by a piston 18C. The damping force generation mechanism 33C includes a case 401C, a solenoid 402C covered by the case 401C, and a piston bolt portion 403C serving as a shaft member. In the damping force generation mechanism 33C, the case 401C is connected to a connection rod 404C. The connection rod 404C passes through the rod guide 22 (see FIG. 1) and the seal member 23 (see FIG. 1) and extends from the cylinder 2 to the outside.

An extension-side damping force generation mechanism 411C is provided on the lower chamber 20 side of the piston 18C, and a compression-side damping force generation mechanism 412C is provided on the upper chamber 19 side of the piston 18C.

The extension-side damping force generation mechanism 411C will be described with reference to FIG. 12.

The oil fluid L that has passed through an extension-side piston-side passage 43C from the upper chamber 19 passes through the extension-side inlet orifice 142 provided in the disc 70, passes through an extension-side inlet port 416C provided in the piston bolt 415C, and enters an extension-side pilot chamber 95C.

The extension-side pilot chamber 95C communicates with the back pressure chamber 184 for the extension-side first damping valve 72 via a pilot communication passage 418C provided in the piston bolt 415C and a passage in the passage groove 124 provided in the pilot case 81B.

A pilot valve 421C installed in the piston bolt 415C receives a valve-closing force by a thrust of the solenoid 402C, and opens when a valve-opening force caused by a biasing force of a spring 422C and a pressure of the pilot chamber 95C exceeds the thrust of the solenoid 402C. When the pilot valve 421C opens, the oil fluid L in the pilot chamber 95C. passes through a compression-side inlet port 424C, opens a disc valve 426C in which a compression-side inlet orifice 425C is provided, passes through a compression-side piston-side passage 44C, and flows into the lower chamber 20.

The oil fluid L that has passed through the extension-side piston-side passage 43C from the upper chamber 19 passes through the extension-side inlet orifice 142 provided in the disc 70, passes through the extension-side inlet port 416C provided in the piston bolt 415C, and enters the extension-side pilot chamber 95C. Thereafter, the oil fluid L that has passed through a passage in a passage groove 30C provided in the piston bolt 415C is introduced into the sub-back pressure chamber 182 of the back pressure chamber 184 through the passage in the passage groove 124 provided in the pilot case 81B, passes through the restriction disc 78B and the communication orifice 166 provided in the disc 77, and enters the main-back pressure chamber 181 of the back pressure chamber 184.

The valve 192B provided in the sub-back pressure chamber 182 partitions the variable chamber 183 and the sub-back pressure chamber 182 into which the oil fluid Lis introduced from the lower chamber 20 via the orifice 313B and the lower chamber communication passage 211B provided in the pilot case 81B. Also, the valve 192B constitutes the check valve 191B that allows only the flow of the oil fluid L from the lower chamber 20 to the back pressure chamber 184 via the orifice 313B and the lower chamber communication passage 211B. During the extension stroke, the check valve 191B is constantly closed to maintain a pilot pressure inside the back pressure chamber 184. When axial movement of the piston 18C is at a high frequency, an amount of deflection of the valve 192B becomes small, resulting in a low internal pressure in the back pressure chamber 184. Also, when the axial movement of the piston 18C is at a low frequency, the amount of deflection of the valve 192B becomes large, resulting in a high internal pressure in the back pressure chamber 184. Therefore, a valve opening pressure of the first damping valve 72 can be changed according to the frequency. This frequency can be adjusted by the inlet orifice 142 provided in the disc 70. Also, the valve opening pressure of the first damping valve 72 can be adjusted by a disc rigidity of the first damping valve 72 at high frequencies, and by a disc rigidity of the second damping valve 84 at low frequencies. A volume compensation for a moving volume of the valve 192B is performed by the lower chamber communication passage 211B and the orifice 313B provided in the pilot case 81B.

When the oil fluid L in the back pressure chamber 184 reaches a predetermined pressure, it passes through the passage in the passage groove 30C, opens the second damping valve 84, and flows into the lower chamber 20. When the first damping valve 72 opens during the extension stroke, the second damping valve 84 opens as described above, thereby allowing the back pressure chamber 184 to communicate with the lower chamber 20. Therefore, the volume compensation of the oil fluid L corresponding to the moving volume of the first damping valve 72 becomes possible.

Here, a diameter of the back pressure chamber 184 is larger than a diameter of the valve seat portion 53 of the piston 18C. Therefore, the extension-side first damping valve 72 receives a pressure of the lower chamber 20 during the compression stroke.

When the pressure in the lower chamber 20 increases and reaches a predetermined pressure during the compression stroke, the valve 192B of the check valve 191B provided in the pilot case 81B opens to introduce the pressure into the back pressure chamber 184, and a valve-closing force due to the back pressure is applied to the first damping valve 72. When this valve-closing force exceeds the valve-opening force due to the pressure in the lower chamber 20 acting on the outer circumferential side of the first damping valve 72, the first damping valve 72 can be prevented from opening during the compression stroke.

The compression-side damping force generation mechanism 412C will be described.

The oil fluid L, that has passed through the compression-side piston-side passage 44C from the lower chamber 20, passes through the compression-side inlet orifice 425C provided in the disc valve 426C and enters a passage in a compression-side passage groove 431C.

The passage in the compression-side passage groove 431C communicates with a back pressure chamber 442C for a compression-side first damping valve 441C via an orifice 455C of a check valve 451C provided in a pilot case 432C.

The pilot valve 421C installed in the piston bolt 415C receives a valve-closing force by the thrust of the solenoid 402C, and opens when the valve-opening force caused by the spring 422C and the pressure of the pilot chamber 95C exceeds the thrust of the solenoid 402C. When the pilot valve 421C opens, the oil fluid L that has entered the passage in the passage groove 431C passes through the extension-side pilot chamber 95C from the compression-side inlet port 424C, opens the disc 70 in which the extension-side inlet orifice 142 is provided, and passes through the extension-side piston-side passage 43C to flow into the upper chamber 19.

The check valve 451C that allows only the flow of the oil fluid L from the upper chamber 19 to the back pressure chamber 442C and an upper chamber communication passage 452C are provided inside the pilot case 432C, and the orifice 455C is provided on an inner circumferential side of the check valve 451C. During the compression stroke, the check valve 451C is constantly closed to maintain a pilot pressure in the back pressure chamber 442C.

When the first damping valve 441C opens during the compression stroke, the back pressure chamber 442C communicates with the upper chamber 19 via the orifice 455C and the passage in the passage groove 431C, and thereby the volume compensation of the oil fluid L corresponding to a moving volume of the first damping valve 441C becomes possible.

A second damping valve 461C, an inner circumferential groove 462C, and a relief communication passage 463C for relieving the pressure in the back pressure chamber 442C, that has reached a predetermined pressure, to the upper chamber 19 are provided at a bottom portion of the pilot case 432C in which the compression-side first damping valve 441C is installed.

A seat of the second damping valve 461C is a non-standard seat, and partitions the relief communication passage 463C and the upper chamber communication passage 452C. An amount of back pressure introduced can be adjusted by a notch 465C provided in the seat.

Here, since a diameter of the back pressure chamber 442C of the first damping valve 441C is larger than a diameter of the valve seat portion 57 of the piston 18C, the compression-side first damping valve 441C receives the pressure of the upper chamber 19 during the extension stroke.

When the pressure in the upper chamber 19 increases and reaches a predetermined pressure during the extension stroke, the check valve 451C opens to introduce the pressure into the back pressure chamber 442C, causing a valve-closing force due to the back pressure to be applied to the first damping valve 441C. When the valve-closing force exceeds a valve-opening force due to the pressure in the upper chamber 19 acting on an outer circumferential side of the first damping valve 441C, the first damping valve 441C can be prevented from opening during the extension stroke.

### INDUSTRIAL APPLICABILITY

According to the above-described embodiments of the present invention, it is possible to provide a shock absorber and a damping force generation mechanism that allow a smooth operation of the damping force generation mechanism. Therefore, industrial applicability is high.

### REFERENCE SIGNS LIST

1, 1A, 1B, 1C Shock absorber
2 Cylinder
18 Piston
19 Upper chamber (first cylinder chamber)
20 Lower chamber (second cylinder chamber)
41 First valve mechanism (valve mechanism)
72 First damping valve (damping force generation member)
78, 78A, 78B Restriction disc (restriction member)
81 Pilot case (biasing force generation member)
101 Bottom portion
166 Communication orifice (second throttle mechanism)
181 Main-back pressure chamber
182 Sub-back pressure chamber
183 Variable chamber
184 Back pressure chamber
191, 191A, 191B Check valve
192, 192A, 192B Valve (movable member)
193, 193A Variable orifice (first throttle mechanism, first throttle portion)
201 First passage
202 Second passage
241, 241, 241B Frequency sensitive mechanism
313B Orifice (first throttle mechanism, first throttle portion)

1. A shock absorber comprising:
a cylinder in which a working fluid is sealed;
a piston fitted into the cylinder to be slidable and partitioning an inside of the cylinder into a first cylinder chamber and a second cylinder chamber;
a first passage through which the working fluid flows from one chamber in the cylinder due to movement of the piston;
a second passage provided parallel to the first passage;
a valve mechanism provided in the first passage and operating when the first cylinder chamber is at an upstream pressure to allow a damping force to be adjusted by a pressure in a main-back pressure chamber;
a frequency sensitive mechanism provided in the second passage and operating when the first cylinder chamber is at an upstream pressure to vary a volume according to movement of a movable member;
a check valve provided in the second passage and operating when the second cylinder chamber is at an upstream pressure; and
a first throttle mechanism provided downstream or upstream of the check valve and operating when the second cylinder chamber is at an upstream pressure to control a flow of the working fluid to the main-back pressure chamber-,
wherein a sub-back pressure chamber is provided between the first throttle mechanism and the main-back pressure chamber.

2. The shock absorber according to claim 1, wherein the movable member also serves as the check valve.

3. (canceled)

4. The shock absorber according to claim 1, wherein the sub-back pressure chamber communicates with the main-back pressure chamber via a second throttle mechanism.

5. (canceled)

6. A shock absorber comprising:
a cylinder in which a working fluid is sealed;
a piston fitted into the cylinder to be slidable and partitioning an inside of the cylinder into a first cylinder chamber and a second cylinder chamber;
a first passage through which the working fluid flows from one chamber in the cylinder due to movement of the piston;
a second passage provided parallel to the first passage;
a valve mechanism provided in the first passage and operating when the first cylinder chamber is at an upstream pressure to allow a damping force to be adjusted by a pressure in a main-back pressure chamber;
a frequency sensitive mechanism provided in the second passage and operating when the first cylinder chamber is at an upstream pressure to vary a volume according to movement of a movable member;
a check valve provided in the second passage and operating when the second cylinder chamber is at an upstream pressure; and
a variable orifice which operates so as to reduce a part of a flow path of the second passage to control the working fluid flowing to the main-back pressure chamber.
